(19) United States
(12) Patent Application Publication
(10) Pub. No.: US 2026/0179242 A1
(43) Pub. Date: Jun. 25, 2026

(54) INFORMATION PROCESSING APPARATUS, INFORMATION PROCESSING METHOD, AND PROGRAM

(71) Applicant: Sony Group Corporation, Tokyo (JP)

(72) Inventor: Seungha YANG, Kanagawa (JP)

(73) Assignee: Sony Group Corporation, Tokyo (JP)

(21) Appl. No.: 18/711,629

(22) PCT Filed: Nov. 17, 2022
(86) PCT No.: PCT/JP2022/042645

§ 371 Date: May 20, 2024

(30) Foreign Application Priority Data
Dec. 28, 2021 (JP) 2021-214087

(51) Int. Cl. G06T 7/70; G06T 7/73

(52) U.S. Cl. CPC G06T 7/70; G06T 7/73; G06T 2207/30244

(57) ABSTRACT

An information processing apparatus according to an embodiment of the present technology includes an acquisition section, a first calculation section, a second calculation section, and a confidence calculation section. The acquisition section acquires each of image information and depth information with respect to a sensing area of a sensor capable of acquiring the image information based on a sensing result of the sensor. The first calculation section estimates a position of the sensor based on the image information, and calculates a first distance between the sensor and the sensing area based on the estimated position of the sensor. The second calculation section calculates a second distance between the sensor and the sensing area based on the depth information. The confidence calculation section calculates confidence of the depth information based on the first distance and the second distance.

### TECHNICAL FIELD

The present technology relates to an information processing apparatus, an information processing method, and a program that can be applied to a traveling robot.

### BACKGROUND ART

Patent Literature 1 discloses an information processing apparatus that creates a three-dimensional map. In this information processing apparatus, the three-dimensional map is updated based on an image captured by an image capturing apparatus. Furthermore, the three-dimensional map is corrected based on feature points in the image captured by the image capturing apparatus. This makes it possible to reduce errors accumulated in the three-dimensional map.

### CITATION LIST

### Patent Literature

Patent Literature 1: Japanese Patent Application Laid-open No. 2021-005399

### DISCLOSURE OF INVENTION

### Technical Problem

There is a demand for a technology capable of precisely creating map information for traveling by a traveling robot or the like.

In view of the above-described circumstances, an object of the present technology is to provide an information processing apparatus, an information processing method, and a program capable of precisely creating the map information.

### Solution to Problem

In order to achieve the above object, an information processing apparatus according to an embodiment of the present technology includes an acquisition section, a first calculation section, a second calculation section, and a confidence calculation section.

The acquisition section acquires each of image information and depth information with respect to a sensing area of a sensor capable of acquiring the image information based on a sensing result of the sensor.

The first calculation section estimates a position of the sensor based on the image information, and calculates a first distance between the sensor and the sensing area based on the estimated position of the sensor.

The second calculation section calculates a second distance between the sensor and the sensing area based on the depth information.

The confidence calculation section calculates confidence of the depth information based on the first distance and the second distance.

In this information processing apparatus, the position of the sensor is estimated based on the image information with respect to the sensing area, and the first distance between the sensor and the sensing area is calculated. Based on the depth information with respect to the sensing area, the second distance between the sensor and the sensing area is calculated. Based on the calculated first distance and the calculated second distance, the confidence of the depth information with respect to the sensing area is calculated. By using the calculated confidence, it is possible to precisely create map information.

The confidence calculation section may calculate the confidence of the depth information based on a difference between the first distance and the second distance.

The confidence calculation section may calculate the confidence of the depth information such that the confidence of the depth information increases as the difference between the first distance and the second distance decreases.

The sensor may be installed on a moving object body configured to be movable on a ground and be movable integrally with the moving object body. In this case, the sensing area may include a peripheral area of the moving object body on the ground. Furthermore, the first calculation section may calculate a shortest distance between the sensor and the peripheral area as the first distance. Furthermore, the second calculation section may calculate the shortest distance between the sensor and the peripheral area as the second distance.

The sensor may be installed at a position on an upper side of the moving object body and toward a lower side.

The first calculation section may calculate a height of the sensor with respect to the moving object body based on the image information, and calculate a total value of the calculated height of the sensor with respect to the moving object body and a height of the moving object body as the first distance.

The moving object body may have a surface included in the sensing area and having feature points arranged thereon. In this case, the first calculation section may calculate the height of the sensor with respect to the moving object body based on image information about the feature point.

The second calculation section may calculate a shortest distance between the sensor and the sensing area as a candidate shortest distance based on the depth information, and may calculate a total value of the candidate shortest distance and the height of the moving object body as the second distance when the candidate shortest distance is a shortest distance between the sensor and the moving object body.

The information processing apparatus may further include a map creation section that creates a depth map in which the sensing area, the depth information, and the confidence of the depth information are associated with each other.

When there is an overlap area that overlaps with the sensing area corresponding to the past created sensing area, the map creation section may create the depth map using the depth information associated with the confidence of the depth information having a highest value in the overlap area.

The confidence calculation section may calculate the confidence of the depth information based on confidence at the time of acquisition of the depth information calculated when the depth information is acquired.

The information processing apparatus may further include a movement control section that controls a movement of the moving object based on the depth map.

The depth map may include presence or absence of an obstacle on the sensing area. In this case, when the confidence of the depth information of the area in which the obstacle is present in the sensing area is relatively high, the movement control section may set the obstacle as a subject to be avoided.

The depth map may include presence or absence of an obstacle on the sensing area. In this case, when the confidence of the depth information of the area in which the obstacle is present in the sensing area is relatively low, the movement control section may not set the obstacle as a subject to be avoided.

The sensor may be a monocular camera. In this case, the acquisition section may acquire the depth information by executing machine learning using the sensing result of the monocular camera as an input.

The sensor may be installed on the moving object body configured to be movable on the ground and be movable integrally with the moving object body. In this case, the information processing apparatus may further include the sensor and the moving object body.

The sensor may be installed on the moving object body configured to be movable on the ground and be movable integrally with the moving object body, and may be configured to be attachable to and detachable from the moving object body.

An information processing method according to an embodiment of the present technology is an information processing method executed by a computer system, and includes acquiring each of image information and depth information with respect to a sensing area of a sensor capable of acquiring the image information based on a sensing result of the sensor.

A position of the sensor is estimated based on the image information, and a first distance between the sensor and the sensing area is calculated based on the estimated position of the sensor.

A second distance between the sensor and the sensing area is calculated based on the depth information.

Confidence of the depth information is calculated based on the first distance and the second distance.

A program according to an embodiment of the present technology causes a computer system to execute a step of acquiring each of image information and depth information with respect to a sensing area of a sensor capable of acquiring the image information based on a sensing result of the sensor, a step of estimating a position of the sensor based on the image information to calculate a first distance between the sensor and the sensing area based on the estimated position of the sensor, a step of calculating a second distance between the sensor and the sensing area based on the depth information, and a step of calculating confidence of the depth information based on the first distance and the second distance.

### BRIEF DESCRIPTION OF DRAWINGS

FIG. 1 is a schematic diagram for explaining an application to a small traveling robot according to an embodiment of the present technology to a last mile delivery.

FIG. 2 is a schematic diagram showing an appearance of the small traveling robot.

FIG. 3 is a schematic diagram showing a functional configuration example of the small traveling robot.

FIG. 4 is a flowchart showing an example of a generation process of a depth map.

FIG. 5 is a flowchart showing a detailed process example of estimating a position and a posture of a monocular camera.

FIG. 6 is a schematic diagram for explaining feature points.

FIG. 7 is a flowchart showing a detailed process example of a depth estimation.

FIG. 8 is a flowchart showing a detailed process example of a confidence calculation.

FIG. 9 is a schematic diagram for explaining a calculation of a height from a surrounding ground of the monocular camera.

FIG. 10 is a schematic diagram for explaining a calculation of a shortest distance from the monocular camera to the surrounding ground.

FIG. 11 is a schematic diagram of a table used for the confidence calculation.

FIG. 12 is a schematic diagram of the depth map created by a map creation section.

FIG. 13 is a flowchart showing a detailed process example of map integration.

FIG. 14 is a schematic diagram of the depth map created by the map creation section.

FIG. 15 is a schematic diagram of the depth map created by the map creation section.

FIG. 16 is a schematic diagram of the depth map in which integrated confidence is associated.

FIG. 17 is a schematic diagram showing an example of a movement path of the small traveling robot.

FIG. 18 is a schematic diagram showing an example of the movement path of the small traveling robot.

FIG. 19 is a schematic diagram showing an example of the movement path of the small traveling robot.

FIG. 20 is a schematic diagram of the small traveling robot or a truck loaded with a traveling robot.

FIG. 21 is a schematic diagram of a sensing area of the small traveling robot or the traveling robot.

FIG. 22 is a schematic diagram of the small traveling robot and a computer.

FIG. 23 is a block diagram showing a hardware configuration example of the computer.

### MODE(S) FOR CARRYING OUT THE INVENTION

Hereinafter, embodiments according to the present technology will be described with reference to the drawings.

### [Application to Last Mile Delivery]

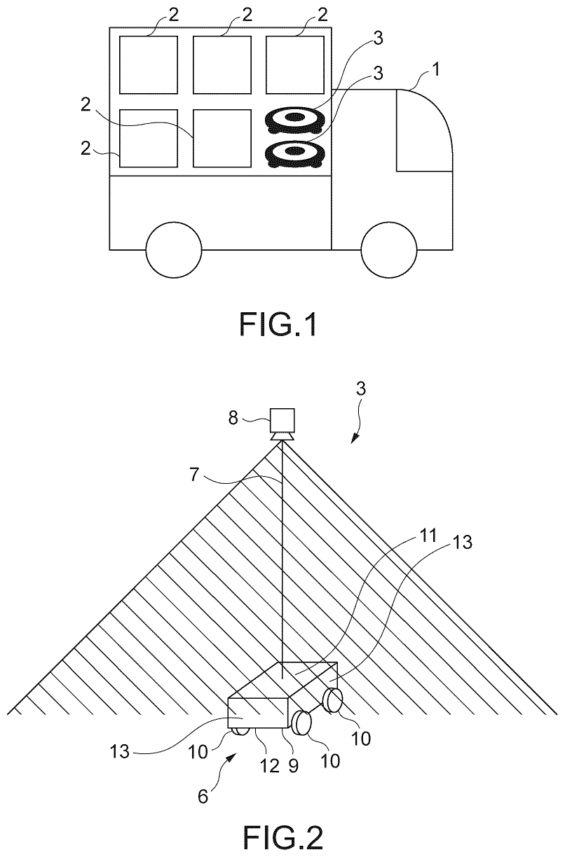

FIG. 1 is a schematic diagram for explaining an application to a small traveling robot to a last mile delivery according to an embodiment of the present technology.

A truck 1 as shown in FIG. 1 is capable of traveling on a wide road without problems. On the other hand, in a residential area or the like, there are many narrow roads, and traffic is inconvenient, so that it is difficult to travel.

Therefore, when packages 2 are delivered from a delivery center of a delivery company to each home, the packages 2 are carried by the truck 1 from the delivery center to an entrance to a residential area. Then, at the entrance of the residential area, the packages 2 are unloaded, and then the packages 2 are loaded on a bogie cart and carried to each home by human power. Such last mile delivery is often employed as a delivery method in logistics.

The last mile delivery refers to “a last 1 mile in logistics” and means a delivery process “from the entrance of the residential area to each home”.

In a situation of the last mile delivery, applicability of a small traveling robot 3 has been sought. When the last mile delivery is executed using the small traveling robot 3, for example, as shown in FIG. 1, the packages 2 and the small traveling robots 3 are loaded and carried on the truck 1.

The packages 2 are loaded on the small traveling robots 3 from the entrance of the residential area, and the packages 2 are carried to each home by autonomous traveling of the small traveling robots 3. In this way, it is expected that the packages 2 are carried on the small traveling robots 3 in place of hands of a person, thereby contributing to efficiency of the logistics.

It should be appreciated that an application of the present technology is not limited to the last mile delivery.

### [Configuration of Small Traveling Robot]

FIG. 2 is a schematic diagram showing an external appearance of the small traveling robot 3.

The small traveling robot 3 includes a moving object body 6, a pole 7, and a monocular camera 8.

In FIG. 1, no pole 7 and no monocular camera 8 are illustrated, and only the moving object bodies 6 included in the small traveling robots 3 are schematically illustrated.

The moving object body 6 has a base part 9 and four tires 10.

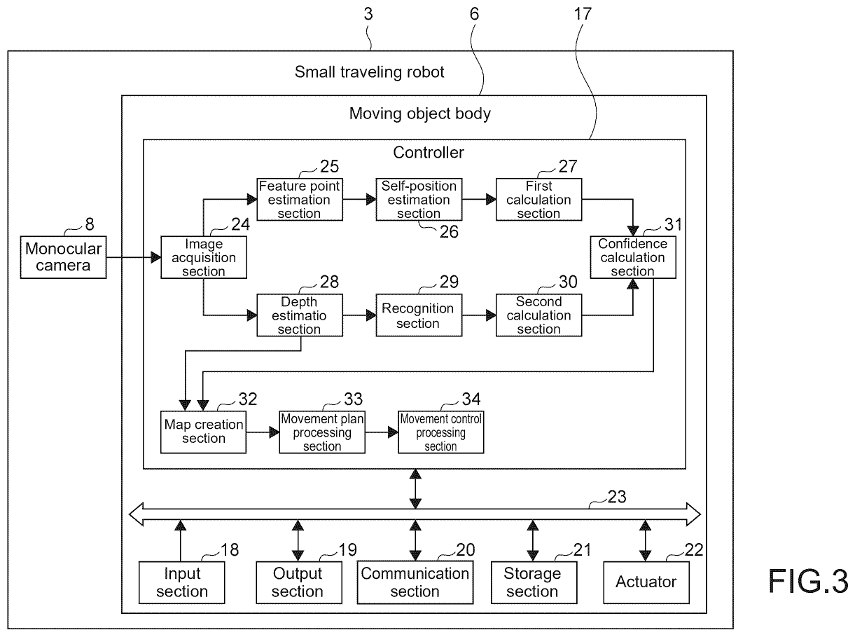

The base part 9 is a component serving as a base body of the moving object body 6. Various mechanisms for driving the small traveling robot 3, such as a controller 17 (see FIG. 3) and a driving motor, are built in the base part 9.

In the example shown in FIG. 2, the shape of the base part 9 is a rectangular parallelepiped, and has an upper surface 11, a lower surface 12, and four side surfaces 13. The shape of the base part 9 is not limited, and may have any shape such as a cylindrical shape or a spherical shape.

Feature points 14 (see FIG. 6) are arranged on the upper surface 11 of the base part 9. This will be described in detail later.

The four tires 10 are arranged on the side surfaces 13 of the base part 9. When each of the four tires 10 is rotationally driven, the traveling of the small traveling robot 3 is realized. That is, the moving object body 6 is configured to be movable on a ground.

The specific configuration, such as the number and the size of the tires 10, is not limited.

Any configuration may be employed as the moving object body 6. For example, an off-the-shelf traveling robot may be used as the moving object body 6. Furthermore, a drone, an autonomous driving vehicle capable of riding, a multi-foot walking type robot, or the like may be used as the moving object body 6.

The pole 7 is a member that supports the monocular camera 8.

The pole 7 is a rod-shaped member, and is made of a rigid material such as metal or plastic. It should be appreciated that a specific material and a shape of the pole 7 are not limited.

As shown in FIG. 2, the pole 7 is installed so as to extend upward from the upper surface 11 of the base body 9. For example, the pole 7 is installed so as to extend in a vertical direction when the moving object body 6 is installed on a horizontal plane. It should be appreciated that it is not limited thereto, and the present technology is also applicable to a case where the pole 7 is installed at an angle slightly intersecting in the upward direction.

The monocular camera 8 is installed at an upper end portion of the pole 7 in a state that an imaging direction is directed downward. That is, the monocular camera 8 is installed at a position on an upper side of the moving object body 6 via the pole 7 toward a lower side. Furthermore, the monocular camera 8 is installed so as to be movable integrally with the moving object body 6.

An angle-of-view range (imaging range) that can be imaged by the monocular camera 8 is a sensing area of the monocular camera 8. In the present embodiment, the sensing area includes the moving object body 6 arranged on the ground and a peripheral area of the moving object body 6 on the ground.

That is, the sensing area is imaged by the monocular camera 8, so that an image including the moving object body 6 and the peripheral area of the moving object body 6 on the ground is acquired as a sensing result.

A frame rate of imaging by the monocular camera 8 is not limited, and may be an arbitrary value.

Hereinafter, the peripheral area of the moving object body 6 on the ground may be referred to as a surrounding ground.

The pole 7 may be configured to be attachable to and detachable from the base part 9.

Furthermore, the monocular camera 8 may be configured to be attachable to and detachable from the pole 7.

For example, when the last mile delivery is executed, the pole 7 is attached to the base part 9 by a delivery person or the like. Furthermore, the monocular camera 8 is attached to an upper end of the pole 7.

Alternatively, the pole 7 may be made in a collapsible form and housed in place in the base part 9. When the last mile delivery is executed, the pole 7 is taken out by the delivery person or the like, and is installed so as to extend upward from the base part 9. Then, the monocular camera 8 is attached to the upper end of the pole 7.

It should be appreciated that the pole 7 may be fixed to the base part 9.

Furthermore, the monocular camera 8 may be fixed to the pole 7.

The small traveling robot 3 shown in FIG. 2 functions as an embodiment of the moving object according to the present technology. The small traveling robot 3 also functions as an embodiment of the information processing apparatus according to the present technology. That is, the small traveling robot 3 can also be considered to be an example in which the information processing apparatus according to the present technology is applied to the moving object.

The monocular camera 8 corresponds to an embodiment of the sensor capable of acquiring the image information according to the present technology. It is not limited to the monocular camera 8, and any camera capable of acquiring the image information may be used.

FIG. 3 is a schematic diagram showing a functional configuration example of the small traveling robot 3.

The moving object body 6 further includes a controller 17, an input section 18, an output section 19, a communication section 20, a storage section 21, and an actuator 22.

In the present embodiment, these blocks are mounted on the base part 9 of the moving object body 6.

In FIG. 3, the pole 7, and the base part 9 and the tires 10 included in the moving object body 6, each of which is included in the small traveling robot 3, are not illustrated.

The controller 17, the input section 18, the output section 19, the communication section 20, the storage section 21, and the actuator 22 are mutually connected to via a bus 23. Instead of the bus 23, each block may be connected using a communication network, a unique communication method that is not standardized, or the like.

The controller 17 includes hardware necessary for configurating a computer, e.g., a processor such as a CPU, a GPU, and a DSP, a memory such as a ROM and a RAM, and a storage device such as an HDD. For example, the CPU loads the program according to the present technology stored in the ROM or the like in advance into the RAM and executes the program, thereby executing the information processing method according to the present technology.

For example, a PLD (Programmable Logic Device) such as an FPGA (Field Programmable Gate Array), or other devices such as an ASIC (Application Specific Integrated Circuit) may be used as the controller 17.

In the present embodiment, the CPU of the controller 17 executes the program according to the present technology (for example, an application program), whereby an image acquisition section 24, a feature point estimation section 25, a self-position estimation section 26, a first calculation section 27, a depth estimation section 28, a recognition section 29, a second calculation section 30, a confidence calculation section 31, a map creation section 32, a movement plan processing section 33, and a movement control processing section 34 are realized as functional blocks.

Then, the information processing method according to the present embodiment is executed by these functional blocks. Note that, in order to realize each functional block, dedicated hardware such as an IC (integrated circuit) may be used, as appropriate.

The image acquisition section 24 acquires the image information with respect to the sensing area of the monocular camera 8 based on the sensing result of the monocular camera 8.

In the present embodiment, as the image information, an image including the moving object body 6 and the surrounding ground is acquired. The image information corresponds to the sensing result of the monocular camera 8.

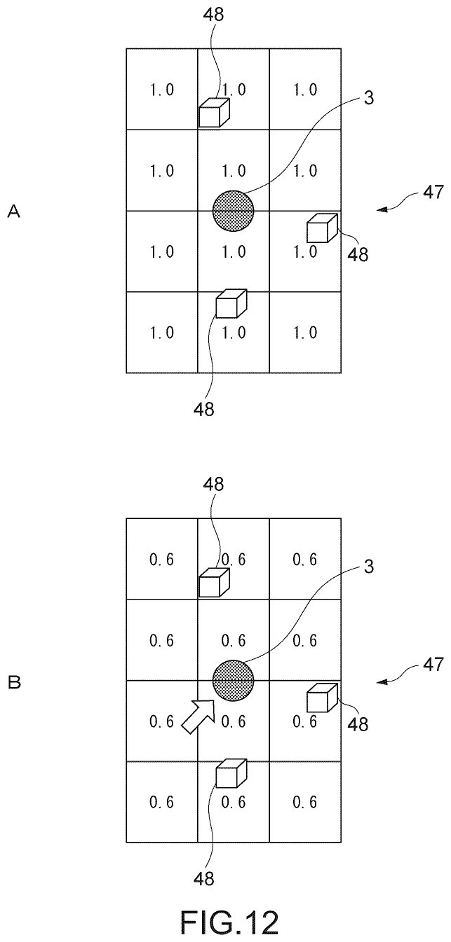

Based on the image information acquired by the image acquisition section 24, each of the feature point extraction section 25, the self-position estimation section 26, the first calculation section 27, the depth estimation section 28, the recognition section 29, the second calculation section 30, the confidence calculation section 31, and the map creation section 32 operates to generate a depth map 47 (see FIG. 12) according to the present technology.

The generation of the depth map 47 and the depth map 47 will be described in detail later.

The feature point extraction section 25 generates image information about the feature points 14 based on the image information acquired from the image acquisition section 24.

The self-position estimation section 26 estimates a self-position of the moving object body 6. Estimation of a position and a posture (self-position) of the moving object body 6 is executed by a technology such as an SLAM (Simultaneous Localization and Mapping).

In addition, in the present embodiment, a position and a posture of the monocular camera 8 are estimated based on the image information about the feature points 14 generated by the feature point extraction section 25.

The first calculation section 27 calculates a distance between the monocular camera 8 and the surrounding ground based on the position of the monocular camera 8 estimated by the self-position estimation section 26.

The distance between the monocular camera 8 and the surrounding ground, which is calculated by the first calculation section 27 based on the position of the monocular camera 8, corresponds to the embodiment of the first distance according to the present technology. Hereinafter, the distance may be referred to as the first distance.

The feature point extraction section 25, the self-position estimation section 26, and the first calculation section 27 correspond to the embodiment of the first calculation section according to the present technology.

The depth estimation section 28 acquires depth information with respect to the sensing area based on the image information acquired from the image acquisition section 24.

Specifically, a monocular depth estimation is executed using the image information as an input, and the depth information with respect to the moving object body 6 or the surrounding ground is acquired.

The image acquisition section 24 and the depth estimation section 28 correspond to the embodiment of the acquisition section according to the present technology.

The recognition section 29 acquires the depth information from the depth estimation section 28, and determines whether or not the depth information is the depth information with respect to the moving object body 6 or the depth information with respect to the surrounding ground.

Note that the image information acquired by the image acquisition section 24 may be used for the determination.

The second calculation section 30 calculates the distance between the monocular camera 8 and the surrounding ground based on the depth information and a determination result acquired from the recognition section 29.

The distance between the monocular camera 8 and the surrounding ground, which is calculated by the second calculation section 30 based on the depth information and the determination result, corresponds to the embodiment of the second distance according to the present technology. Hereinafter, the distance may be referred to as the second distance.

The recognition section 29 and the second calculation section 30 correspond to the embodiment of the second calculation section according to the present technology.

The confidence calculation section 31 calculates confidence of the depth information based on the first distance calculated by the first calculation section 27 and the second distance calculated by the second calculation section 30.

In the present embodiment, the confidence is calculated by a table in which the first distance and the second distance are input and the confidence is output.

The map creation section 32 creates the depth map 47 based on the confidence calculated by the confidence calculation section 31.

The movement plan processing section 33 generates a movement plan of the small traveling robot 3 based on the depth map 47 created by the map creation section 32.

Specifically, the movement plan including a trajectory, a speed, an acceleration, and the like of the movement of the small traveling robot 3 is generated and output to the movement control processing section 34.

The movement control processing section 34 controls the movement of the small traveling robot 3 based on the movement plan generated by the movement plan processing section 33.

For example, a control signal that controls a specific movement of the actuator 22 is generated to operate the actuator 22.

The movement plan processing section 33 and the movement control processing section 34 correspond to the embodiment of the movement control section according to the present technology.

The input section 18 includes a device used by a user who uses the small traveling robot 3 to input various types of data, instructions, and the like. For example, an operation device such as a touch panel, a button, a switch, a keyboard, and a pointing device is provided.

The output section 19 includes a device that outputs various kinds of information to the user.

For example, information about the depth map 47 and the movement plan is displayed on the display.

Alternatively, a warning (“do not approach” or the like) may be informed by a speaker to a pedestrian or the like present in the vicinity of the small traveling robot 3.

The communication section 20 is a communication module that communicates with other devices via a network such as a WAN or a LAN. The communication module for near field wireless communication, such as Bluetooth (trademark), may be provided. Furthermore, communication equipment such as a modem or a router may be used.

For example, the communication section 20 executes communication between the small traveling robot 3 and external equipment.

The storage section 21 is a storage device such as a nonvolatile memory, and for example, an HDD, as SSD, or the like is used. In addition, any computer-readable non-transient storage medium may be used.

The storage section 21 stores a control program for controlling overall operation of the small traveling robot 3. A method of installing the control program, content data, and the like is not limited.

In addition, the storage section 21 stores various kinds of information such as the depth map 47 and an action plan.

The actuator 22 includes a configuration for realizing the movement of the small traveling robot 3.

For example, as the actuator 22, a driving motor is built in the base part 9, and rotation of the tires 10 is realized. The actuator 22 operates based on the control signal generated by the movement control processing section 34.

Note that the specific configurations of the input section 18, the output section 19, the communication section 20, the storage section 21, and the actuator 22 are not limited.

### [Map Generation Process]

A generation process of the depth map 47 in the present embodiment will be described.

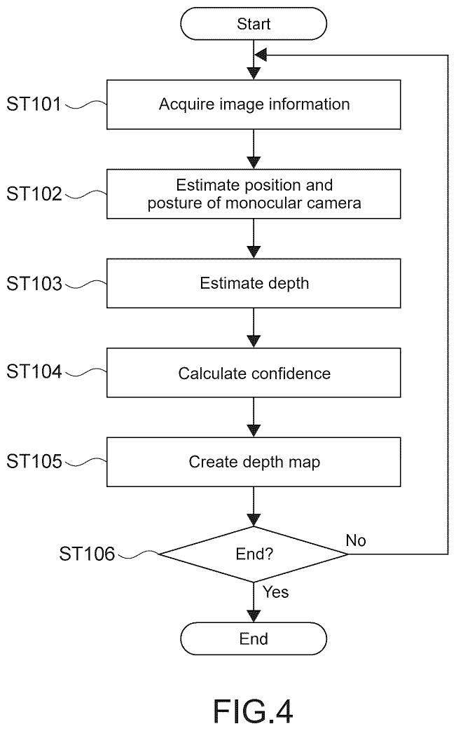

FIG. 4 is a flowchart showing an example of the generation process of the depth map 47.

A series of processes of steps 101 to 105 shown in FIG. 4 is executed at a predetermined frame rate (such as 30 fps and 60 fps). It should be appreciated that the frame rate is not limited, and may be appropriately set in accordance with throughput of the hardware or the like.

The image information is acquired by the image acquisition section 24 (Step 101).

Specifically, the monocular camera 8 first executes imaging, and images of the moving object body 6 and the surrounding ground are acquired. Furthermore, the image acquisition section 24 acquires the image as the image information.

### [Self-Position Estimation of Monocular Camera]

The position and the posture of the monocular camera 8 are estimated (Step 102).

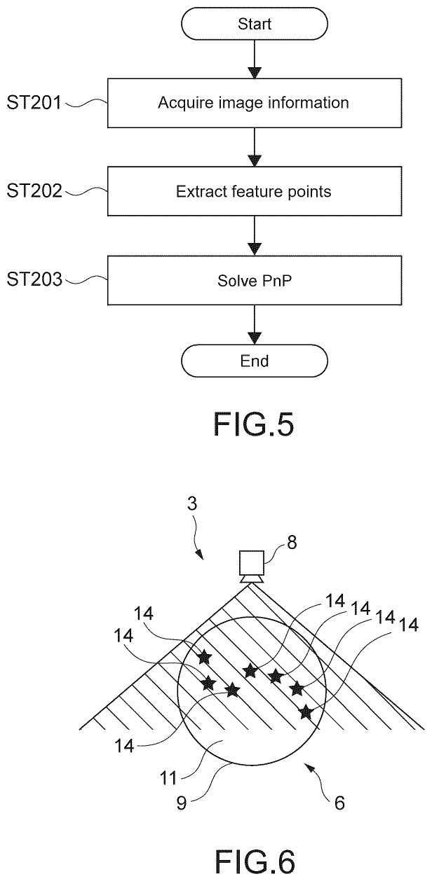

FIG. 5 is a flowchart showing a detailed process example of Step 102.

First, the feature points 14 used in the self-position estimation of the monocular camera 8 will be described.

### [Feature Points]

FIG. 6 is a schematic diagram for explaining the feature points 14.

In FIG. 6, the pole 7 and the like included in the small traveling robot 3 are not illustrated.

In the present embodiment, the moving object body 6 has a surface on which the feature points 14 are arranged.

Specifically, as shown in FIG. 6, markers are arranged on the upper surface 11 of the base part 9 as the feature points 14.

Each marker has a star shape, and seven markers are arranged in a curved line. It should be appreciated that shapes, colors, numbers, arrangements, and the like of the feature points 14 are not limited. Furthermore, marks or objects other than the markers may be arranged as the feature points 14.

The upper surface 11 on which the feature points 14 are arranged is included in the sensing area of the monocular camera 8. Accordingly, the image acquired by the monocular camera 8 in Step 101 will be the image including the feature points 14.

The image information acquired by the image acquisition section 24 is also the image including the feature points 14. Therefore, the image information acquired by the image acquisition section 24 can also be considered as the image information including the feature points 14.

As shown in FIG. 5, the feature point extraction section 25 acquires the image information from the image acquisition section 24 (Step 201).

The image information acquired from the feature point extraction section 25 will be the image information including the feature points 14.

The feature point extraction section 25 extracts the feature points 14 (Step 202).

First, the feature point extraction section 25 generates a coordinate of respective feature points 14 based on the acquired image information.

Specifically, the feature point extraction section 25 generates two types of coordinates, i.e., a 2D point (two-dimensional point) and a 3D point (three-dimensional point) of the feature points 14.

The 2D point is a two-dimensional coordinate of the feature points 14 in the image information. For example, a two-dimensional coordinate system is set in the image information (the image including the feature points 14), and the positions of the feature points 14 in the image are represented by the two-dimensional coordinate.

The 3D point is a three-dimensional coordinate of the feature points 14. For example, a three-dimensional coordinate system having a predetermined position as a reference position is set, and the three-dimensional coordinate of the feature points 14 is expressed. The reference position is not limited, and may be any position, for example, the center of the upper surface 11 of the base part 9.

Also, coordinate systems representing the 2D point and the 3D point are not limited. Any coordinate system may be used, for example, an orthogonal coordinate system or a polar coordinate system.

Furthermore, the feature point extraction section 25 generates the image information about the feature points 14.

In the present embodiment, information in which three types of information such as the image including the feature points 14, the 2D point, and the 3D point are associated is generated as the image information about the feature points 14.

The image information about the feature points 14 generated by the feature point extraction section 25 is output to the self-position estimation section 26, and is used for estimating the position and posture of the monocular camera 8.

The image information about the feature points 14 generated by the feature point extraction section 25 is not limited, and any information that can be used for estimating the position and the posture of the monocular camera 8 may be generated.

By the self-position estimation section 26, Solve PnP (Perspective-n-Point) is executed (Step 203).

The Solve PnP is a method of estimating the position and the posture of the camera from the 2D point and the 3D point of the feature points 14 captured by the camera.

In the present embodiment, the Solve PnP is executed by the self-position estimation section 26 based on the image information about the feature points 14 acquired from the feature point extraction section 25, and the position and the posture of the monocular camera 8 are estimated.

The position of the monocular camera 8 is represented by three values of an X coordinate, a Y coordinate, and a Z coordinate in the orthogonal coordinate system with a predetermined position as a reference, for example.

The posture of the monocular camera 8 is represented by three values, for example, a pitch (pitch), a yaw (yaw), and a roll (roll).

It should be appreciated that a method of representing the position and the posture is not limited, and an arbitrary method may be employed.

In addition, the position and the posture of the monocular camera 8 may be estimated based on the image information by other methods than the Solve PnP.

The estimated position and posture of the monocular camera 8 are output to the first calculation section 27.

Note that the position and the posture of the moving object body 6 may be estimated at the same time as the position and the posture of the monocular camera 8 are estimated in Step 103.

### [Depth Estimation]

The depth estimation section 28 estimates the depth with respect to the sensing area (Step 103).

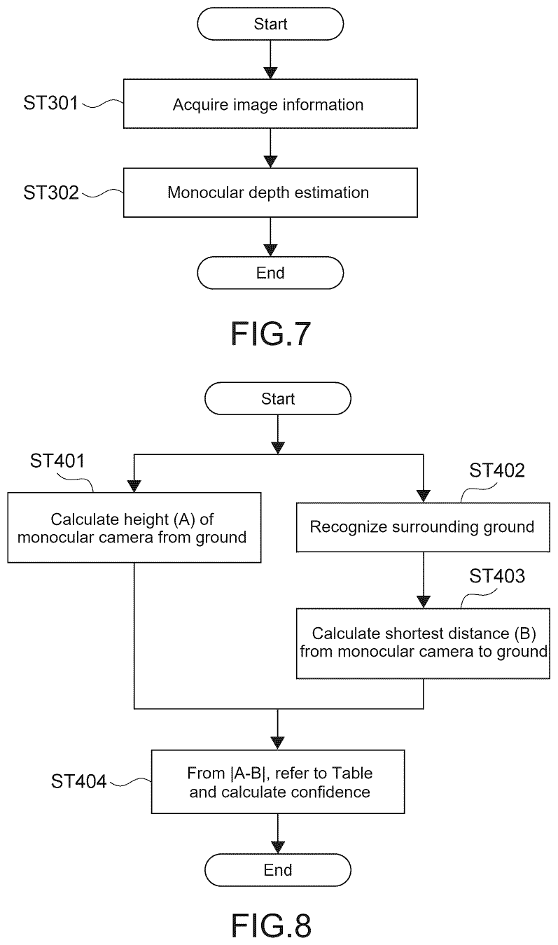

FIG. 7 is a flowchart showing a detailed process example of Step 103.

The depth estimation section 28 acquires the image information from the image acquisition section 24 (Step 301).

Furthermore, the monocular depth estimation is executed by the depth estimation section 28 (Step 302).

In the present embodiment, the depth estimation section 28 acquires the depth information by executing the machine learning using the image information as the input.

Specifically, for example, the depth estimation section 28 includes a learning section and an identification section (not illustrated).

The learning section executes the machine learning based on input learning data (the image information), and outputs a learning result (the depth information). Furthermore, the identification section executes identification (determination, prediction, or the like) of the input learning data based on the input learning data and the learning result.

For example, deep learning is used as a learning method in the learning section. The deep learning is a model that uses a neural network having a multilayer structure, and is capable of repeating characteristic learning in each layer and learning complex patterns hidden in a large amount of data.

The deep learning is used to, for example, identify an object in an image and a word in voice. It should be appreciated that it can also be applied to calculate the depth information according to the present embodiment.

It should be appreciated that other learning methods, such as a learning method using the neural network, may be used.

The learned depth estimation section 28 acquires the depth information with respect to the sensing area by using the image information as the input.

For example, a depth value of each pixel of the image information is acquired as the depth information.

The depth information with respect to the acquired sensing area is output to the recognition section 29.

### [Confidence Calculation]

The confidence of the depth information is calculated (Step 104).

FIG. 8 is a flowchart showing a detailed process example of Step 104.

A height of the monocular camera 8 from the surrounding ground is calculated by the first calculation section 27 (Step 401).

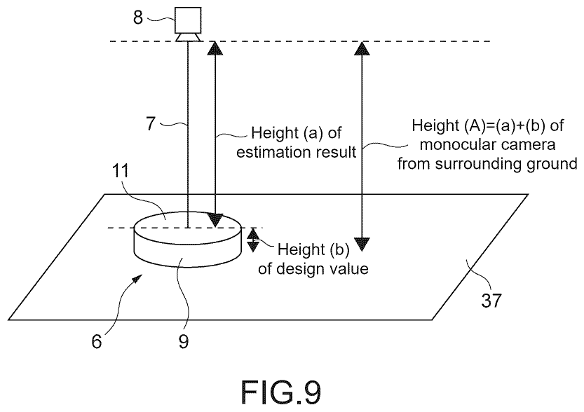

FIG. 9 is a schematic diagram for explaining the calculation of the height of the monocular camera 8 from the surrounding ground.

First, the first calculation section 27 acquires the position and the posture of the monocular camera 8 estimated by the self-position estimation section 26.

Next, the first calculation section 27 calculates the height of the monocular camera 8 with respect to the moving object body 6.

The height of the monocular camera 8 with respect to the moving object body 6 corresponds to a distance in the vertical direction between the upper surface 11 of the base part 9 of the moving object body 6 and the monocular camera 8. In FIG. 9, the distance is illustrated by an arrow as “a height (a) of an estimation result”.

In the present embodiment, the height (a) is calculated based on the position of the monocular camera 8 estimated by the self-position estimation section 26.

Specifically, the height (a) is calculated based on the Z coordinate of the position among the position and the posture acquired by the first calculation section 27.

For example, when the reference position of the coordinate system representing the position is on the upper surface 11, the values of the Z coordinate and the height (a) are equal. Therefore, the first calculation section 27 calculates the value of the Z coordinate as it is as the height (a).

Even when the reference position of the coordinate system is not on the upper surface 11, it is possible to calculate the height (a) by calculating a difference in the distance in the vertical direction between the reference position of the coordinate system and the upper surface 11 and adding or subtracting the difference to the Z coordinate.

It should be appreciated that the height (a) may be calculated based on values other than the Z coordinate, for example, values such as the X coordinate and the Y coordinate of the position, and the pitch, the yaw, and the roll of the posture. In addition, a specific calculation method of the height (a) is not limited.

Furthermore, the first calculation section 27 calculates a height (A) of the monocular camera 8 from a surrounding ground 37. In FIG. 9, the height (A) is illustrated by an arrow.

In FIG. 9, a height (b) of a design value is illustrated by an arrow. The height (b) of the design value is the height of the moving object body 6 and is a known value.

As shown in FIG. 9, since the height (a) is the height of the monocular camera 8 with respect to the moving object body 6, a value obtained by adding the height (b) to this value is the height (A) of the monocular camera 8 with respect to the surrounding ground 37.

Therefore, a total value of the height (a) and the height (b) is calculated as the height (A) by the first calculation section 27.

The height (A) can also be considered as a first distance (the distance between the monocular camera 8 and the surrounding ground 37).

In this way, in the present embodiment, the first calculation section 27 calculates the shortest distance between the monocular camera 8 and the surrounding ground 37 as the first distance.

Specifically, the distance in the direction in which the distance is the shortest among all the directions, that is, in the vertical direction, is calculated as the first distance.

This makes it possible to precisely calculate the first distance.

It should be appreciated that the distance other than the shortest distance between the monocular camera 8 and the surrounding ground 37 may be calculated by the first calculation section 27. For example, a distance in a direction slightly intersecting the vertical direction may be calculated.

Such a distance other than the shortest distance can also be referred to as the first distance.

In the present embodiment, the height (a) is calculated based on the image information about the feature points 14. Furthermore, the total value of the height (a) and the height (b) is calculated as the height (A).

By using such a calculation method, the height (a) and the height (A) are precisely calculated.

The recognition section 29 executes recognition of the surrounding ground 37 (Step 402).

Specifically, the recognition section 29 first acquires the depth information with respect to the sensing area from the depth estimation section 28.

The sensing area includes the moving object body 6 and the surrounding ground 37. Therefore, the depth information (the depth value for each pixel) acquired by the recognition section 29 may include both the depth value with respect to the moving object body 6 and the depth value with respect to the surrounding ground 37. The recognition section 29 determines, for each pixel, which the depth value is for.

The determination by the recognition section 29 is executed based on the acquired depth information. For example, the image information may be acquired from the image acquisition section 24, and the determination may be executed based on the image information. Also, both the depth information and the image information may be used for determination.

The recognition section 29 outputs the depth information and the determination result with respect to the sensing area to the second calculation section 30.

The second calculation section 30 calculates a shortest distance from the monocular camera 8 to the surrounding ground 37 (Step 403).

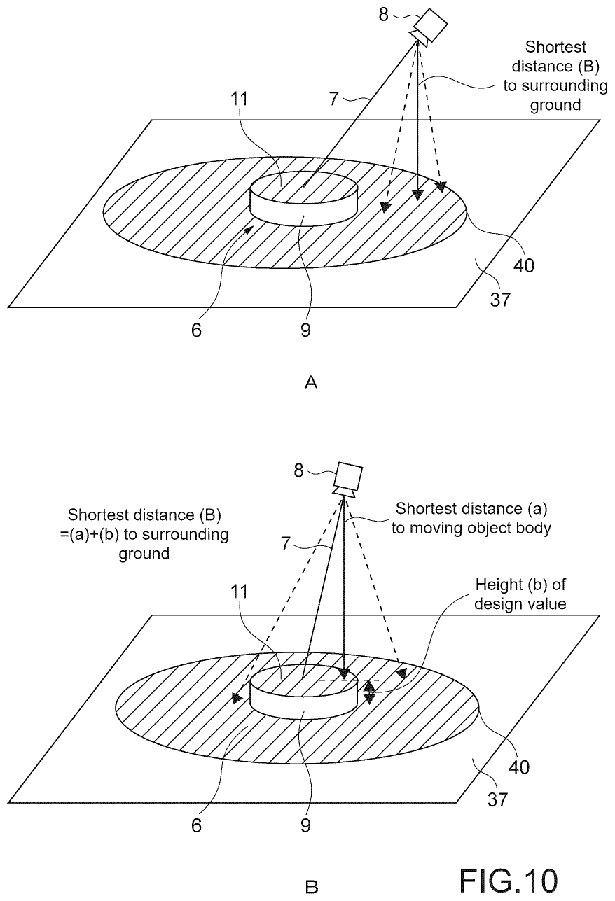

FIG. 10 is a schematic diagram for explaining calculation of the shortest distance from the monocular camera 8 to the surrounding ground 37.

In A and B of FIG. 10, a shortest distance (B) from the monocular camera 8 to the surrounding ground 37 is illustrated by an arrow.

In A and B FIG. 10, a state in which the small traveling robot 3 is travelled and the pole 7 and the monocular camera 8 are tilted by inertia is illustrated.

The second calculation section 30 acquires the depth information with respect to the sensing area from the recognition section 29. The depth information may include both the depth value with respect to the moving object body 6 and the depth value with respect to the surrounding ground 37.

Next, the second calculation section 30 calculates a smallest depth value among the acquired depth information (the depth value for each pixel).

For example, in the state of A of FIG. 10, since the imaging direction of the monocular camera 8 faces the center of the upper surface 11 of the base part 9, an imaging range 40 is a predetermined range with reference to the center of the upper surface 11. In A of FIG. 10, the imaging range 40 is shown by diagonal lines.

The imaging range 40 includes both the moving object body 6 and the surrounding ground 37. Therefore, the depth information acquired by the second calculation section 30 also includes both the depth value with respect to the moving object body 6 and the depth value with respect to the surrounding ground 37.

Furthermore, in this example, the monocular camera 8 is positioned vertically above the surrounding ground 37, and is not positioned vertically above the moving object body 6. Therefore, the smallest depth value is the depth value of the pixel in which the surrounding ground 37 vertically below the monocular camera 8 is imaged.

Even in the state of B of FIG. 10, similar to A of FIG. 10, the imaging range 40 includes both the moving object body 6 and the surrounding ground 37. The depth information acquired by the second calculation section 30 also includes both the depth value with respect to the moving object body 6 and the depth value with respect to the surrounding ground 37.

In this example, the monocular camera 8 is positioned vertically above the moving object body 6. Therefore, the smallest depth value is the depth value of the pixel in which the moving object body 6 vertically below the monocular camera 8 is imaged.

Therefore, the “smallest depth value” calculated by the second calculation section 30 is the depth value of the pixel in which a vertical lower portion of the monocular camera 8 is imaged, and is the depth value with respect to either the moving object body 6 or the surrounding ground 37.

Next, the second calculation section 30 calculates a candidate shortest distance based on the “smallest depth value”.

The candidate shortest distance is the shortest distance between the monocular camera 8 and the sensing area.

That is, the distance in the vertical direction between the monocular camera 8 and an object (either the moving object body 6 or the surrounding ground 37) positioned vertically below the monocular camera 8 is calculated.

Note that a method of calculating the candidate shortest distance is not limited, and an arbitrary method of calculating the distance based on the depth value may be used.

Furthermore, the second calculation section 30 determines whether or not the “smallest depth value” used for calculation of the candidate shortest distance is the depth value with respect to the moving object body 6 or the depth value with respect to the surrounding ground 37. The determination is executed based on the determination result acquired from the recognition section 29.

In the state of A of FIG. 10, it is determined that the “smallest depth value” is the depth value with respect to the surrounding ground 37. In this case, the second calculation section 30 determines that the candidate shortest distance is the distance in the vertical direction between the monocular camera 8 and the surrounding ground 37. That is, the candidate shortest distance is the shortest distance (B) shown in A of FIG. 10.

In the state of B of FIG. 10, it is determined that the “smallest depth value” is the depth value with respect to the moving object body 6. In this case, the second calculation section 30 determines that the candidate shortest distance is the distance in the vertical direction between the monocular camera 8 and the moving object body 6. That is, the candidate shortest distance is a shortest distance (a) to the moving object body 6 shown in B of FIG. 10.

In this case, the value obtained by adding the height (b) of the design value to the shortest distance (a) is the shortest distance (B) to the surrounding ground 37.

Therefore, the second calculation section 30 calculates the total value of the shortest distance (a) and the height (b) as the shortest distance (B).

In this way, the shortest distance (B) is calculated by the second calculation section 30 in both cases where the monocular camera 8 is positioned vertically above the surrounding ground 37 (in the case of A of FIG. 10) and where the camera is positioned vertically above the moving object body 6 (in the case of B of FIG. 10).

As a result, the shortest distance (B) is precisely calculated.

The shortest distance (B) can also be considered as the second distance (the distance between the monocular camera 8 and the surrounding ground 37).

By calculating the shortest distance as the second distance, it is possible to precisely calculate the second distance.

It should be appreciated that the distance other than the shortest distance between the monocular camera 8 and the surrounding ground 37 may be calculated by the second calculation section 30. For example, a distance in a direction slightly intersecting the vertical direction may be calculated.

Such a distance other than the shortest distance can also be considered as the second distance.

Note that a specific calculation method of the first distance and the second distance is not limited.

For example, an arbitrary method of calculating the distance between the sensor and the sensing area as the first distance based on the estimated position of the sensor may be employed. In addition, an arbitrary method of calculating the distance between the sensor and the sensing area as the second distance based on the depth information may be employed.

The confidence calculation section 31 calculates the confidence (Step 404).

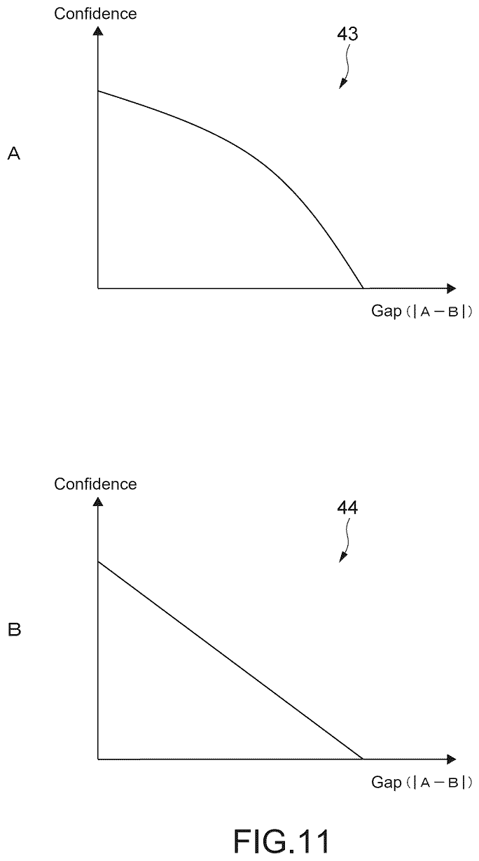

FIG. 11 is a schematic diagram of a table used for the confidence calculation.

In the present embodiment, the confidence calculation section 31 calculates the confidence of the depth information based on a difference between the height (A) calculated by the first calculation section 27 and the shortest distance (B) calculated by the second calculation section 30.

Specifically, the table (a confidence reference table) is used to calculate the confidence.

For example, a table 43 shown in A of FIG. 11 is used to calculate the confidence.

On the horizontal axis of the table 43, a gap (an absolute value of the difference between the height (A) and the shortest distance (B)) is taken. The absolute value of the difference between the height (A) and the shortest distance (B) corresponds to an embodiment of the difference between the first distance and the second distance according to the present technology.

On the vertical axis of the table 43, the confidence of the depth information is taken.

That is, the table 43 is a table in which the gap is input and the confidence is output.

First, the confidence calculation section 31 acquires the height (A) calculated by the first calculation section 27 and the shortest distance (B) calculated by the second calculation section 30.

Furthermore, the confidence calculation section 31 calculates the gap, and the calculated gap is input to the table 43, whereby calculating the confidence.

In the present embodiment, a value in the range of 0.0 to 1.0 is calculated as the confidence.

For example, when the gap is a value close to 0, the calculated confidence is a value close to 1.0.

Furthermore, as the gap increases to some extent, the calculated confidence decreases to 0.8, 0.6 . . . .

In the present embodiment, the table 43 is a monotonically decreasing table (a table in which the output confidence decreases as the input gap increases).

Therefore, the confidence calculation section 31 calculates the confidence of the depth information so that the confidence of the depth information increases as the difference between the height (A) and the shortest distance (B) decreases.

The monotonically decreasing table is not limited to a table in which the relationship between the gap and the confidence is a curve as in the table 43. For example, a table 44 in which the relationship between the gap and the confidence is a straight line as shown in B of FIG. 11 may be used.

By using the table, it is possible to precisely calculate the confidence. In addition, an efficient process is possible.

Alternatively, any monotonically decreasing table may be used.

As the table 43, a table other than the monotonically decreasing table may be used. For example, a table in which the confidence increases in the middle as the gap increases may be used.

Alternatively, the confidence may be calculated by a function or the like.

In addition, a specific method of calculating the confidence is not limited.

In FIG. 8, the processes of Step 401 (calculation of the height), Step 402 (recognition of the ground) and Step 403 (calculation of the shortest distance) are illustrated in parallel, but the process order of each is not limited. For example, the process of either Step 401 or Step 402 may be executed first.

### [Depth Map]

The map creation section 32 creates the depth map 47 (Step 105).

FIG. 12 is a schematic diagram of the depth map 47 created by the map creation section 32.

The depth map 47 is information in which a position in in a certain area and the depth value in the position are associated in the area.

For example, by a sensor capable of acquiring the depth value, the depth value for each position in the area with reference to the position of the sensor is acquired. For example, the depth values for respective positions are acquired, such as the depth value of position A of 30, the depth value of position B of 50 . . . .

The information associated with the position and the depth value is then generated as the depth map 47.

For example, when a hole is present at a certain position, the depth value inside the hole becomes a relatively large value.

Conversely, when a convex portion (for example, a raised ground surface or the like) is present, the depth value of the convex portion is relatively small.

In this way, at the position where an obstacle is present, the depth value changes as compared with the surroundings. Therefore, it is also possible to obtain information about the position where the obstacle is present based on the depth value. Such information may be included in depth map 47.

For example, by using the depth map 47 when the moving object travels, efficient traveling is realized.

Specifically, the moving object can travel while avoiding the obstacle or selecting a shortest route to a destination based on the depth map 47.

In the present embodiment, the map creation section 32 creates the depth map 47 in which the sensing area, the depth information, and the confidence of the depth information are associated with each other.

A of FIG. 12 illustrates the depth map 47 created by the map creation section 32. In addition, the small traveling robot 3 is schematically illustrated as a circle having a shaded pattern.

For example, the depth map 47 is created in a predetermined area using the small traveling robot 3 as a reference.

In the present embodiment, the depth map 47 is created in a rectangular area centered on the small traveling robot 3. The rectangular area is included in the imaging range 40 (sensing area) of the monocular camera 8.

It should be appreciated that the reference position, the shape, the range, and the like of the area are not limited.

Specifically, the map creation section 32 first acquires the depth information with respect to the sensing area from the depth estimation section 28.

In addition, the map creation section 32 acquires the confidence from the confidence calculation section 31.

Furthermore, the map creation section 32 extracts information in which the position of each of the rectangular areas and the depth value are associated. Since the rectangular area is an area included in the sensing area, it is possible to extract only information in which the positions of each of the rectangular areas and the depth value are associated from, for example, the depth information with respect to the acquired sensing area (information in which the positions of each of the sensing areas and the depth value are associated).

A of FIG. 12 schematically illustrates the rectangular areas divided into grids. The areas are divided into rectangular 12 grids arranged in four grids in the vertical direction and three grids in the horizontal direction.

For example, for each pixel range (20 pixels×20 pixels or the like) of the image imaged by the monocular camera 8, the area is divided by using a range of the area corresponding to the pixel range as one grid. It should be appreciated that the specific range, the shape, and the like of the grid are not limited.

Each grid serves as a process unit for the position. That is, the process by the map creation section 32 or the like is executed with one grid as one position.

Note that the method of processing by the map creation section 32 or the like is not limited to the method using the grid.

For example, when the X coordinate of the grid is 1 to 3 in order from the left side and the Y coordinate is 1 to 4 in order from the lower side, the position of the grid is expressed by the map creation section 32 as:

$$( X , Y ) = ( 1 , 3 )$$

$$( X , Y ) = ( 2 , 4 ) .$$

In addition, the map creation section 32 generates information in which the position of the grid and the depth value are associated. Such information is, for example, expressed as the following form:

$$D ( X , Y ) .$$

For example, the fact that the depth value at the position (1,3) is 50, it is expressed as:

$$D ( 1 , 3 ) = 50.$$

In the present embodiment, since the area is divided into 12 grids, the generated information (D (X, Y)) also includes 12 types: D (1, 1) to D (3, 4).

In this example, although the position of the grid is expressed only by the X coordinate and the Y coordinate in order to make the description easy to understand, the position may include the Z coordinate. In this case, the information in which the position of the grid and the depth value are associated is, for example, expressed as:

$$D ( X , Y , Z ) , etc .$$

The map creation section 32 further associates the confidence with the information (D (X, Y)) in which the position and the depth value are associated.

The information is referred to as, for example, a depth with confidence, which is expressed as:

$$Dconf = ( D ( X , Y ) , confidence ) .$$

Note that “confidence” represents the confidence at the position (X, Y).

Each time a series of processes, Steps 101 to 105 shown in FIG. 4, is executed once, the map creation section 32 acquires one type of the confidence. Therefore, one type of the same confidence is associated with each of 12 types of information (D (X, Y)) by the map creation section 32. For example, when the acquired confidence is 1.0, then the depth with confidence includes 12 types of information as follows:

$$Dconf = ( D ( 1 , 3 ) , 1. )$$

$$Dconf = ( D ( 2 , 4 ) , 1. ) .$$

A of FIG. 12 illustrates the confidence corresponding to each position. In this way, confidence 1.0 is uniformly associated with all the 12 types of positions.

A plurality of depths with confidence generated in this way forms the depth map 47. In other words, the depth map 47 can be considered to be the depth map 47 in which the sensing area, the depth information, and the confidence of the depth information are associated to each other.

The specific information of the depth map 47 to be created is not limited, and may be any information in which the sensing area, the depth information, and the confidence of the depth information are associated with each other. In addition, any map information other than the depth map 47 may be created, and a specific method of creating the map information is not limited.

In the present embodiment, a frame number is further associated with the depth with confidence (Dconf). The information in which the frame number is associated with the depth with the confidence may be, for example, expressed by as follows:

$$Dconf ( N ) = ( D ( 1 , 3 ) ( N ) , confidence ) and the like .$$

Hereinafter, Dconf (N) may be described as the depth with the confidence without being distinguished from Dconf.

The frame number is a parameter showing a temporal unit of processes, and for example, the series of processes shown in FIG. 4 is executed once per one frame.

That is, 12 types of the depth with confidence in the frame 0 is first generated:

$$Dconf ( 0 ) = ( D ( 1 , 3 ) ( 0 ) , 1. )$$

$$Dconf ( 0 ) = ( D ( 2 , 4 ) ( 0 ) , 1. ) , etc .$$

Next, the series of processes shown in FIG. 4 is executed again in the frame 1. Then, the depth with the confidence is generated, for example, as follows:

$$Dconf ( 1 ) = ( D ( 2 , 4 ) ( 1 ) , 0.6 ) , etc .$$

In this example, different confidence is associated with the respect to the same coordinate (2, 4), such that the confidence in the frame 0 is associated with 1.0, and the confidence in the frame 1 is associated with 0.6.

Since the map creation section 32 acquires one type of confidence for each frame, the confidence may be different when the frame number is different even if the confidence is thus with respect to the same coordinate. This is also true for the depth values.

In an example shown in B of FIG. 12, the depth map 47 created by the map creation section 32 is shown while the small traveling robot 3 is moving.

The first distance (height (A)) calculated by the first calculation section 27 and the second distance (shortest distance (B)) calculated by the second calculation section 30 are both the same “shortest distance between the monocular camera 8 and the surrounding ground 37”. Ideally, therefore, there is no difference between the first distance and the second distance.

However, when the small traveling robot 3 is moving, an error may occur in the self-position estimation of the monocular camera 8 or the result of the depth estimation due to vibration of the monocular camera 8 or the like. Accordingly, the first distance and the second distance also have relatively inaccurate values, and a difference occurs between the first distance and the second distance.

That is, the gap calculated based on the difference between the first distance and the second distance has a relatively large value. Then, a relatively low value is calculated as the confidence.

In the example shown in B of FIG. 12, since the small traveling robot 3 is moving, a relatively lower value of 0.6 is calculated as the confidence.

When the small traveling robot 3 moves faster, the monocular camera 8 vibrates vigorously, and the confidence may be calculated lower.

In A and B of FIG. 12, obstacles 48 present on the area are schematically shown in cubes.

As the depth map 47, the map creation section 32 may create the depth map 47 including information about the obstacles 48.

For example, the depth map 47 may include presence or absence of the obstacles on the sensing area.

For example, in the example shown in A and B of FIG. 12, the obstacles 48 are present at the positions of:

(2, 1)
(2, 4)
(3, 2).

In this case, the presence or absence of the obstacles 48 is further associated with the depth with the confidence, for example, the information such as:

$$Dconf ( 1 ) = ( D ( 1 , 3 ) ( 1 ) = 50 , 1. , no obstacles )$$

$$Dconf ( 1 ) = ( D ( 2 , 4 ) ( 1 ) = 30 , 1. , with obstacles )$$

is generated.

The presence or absence of the obstacles 48 can be determined based on the depth value or the like.

It should be appreciated that a specific expression method of the information associated with the presence or absence of the obstacles 48 is not limited.

In addition, as the information about the obstacles 48, information about the size, the height, the type, and the like of the obstacles 48 may be included in the depth map 47.

### [Map Integration]

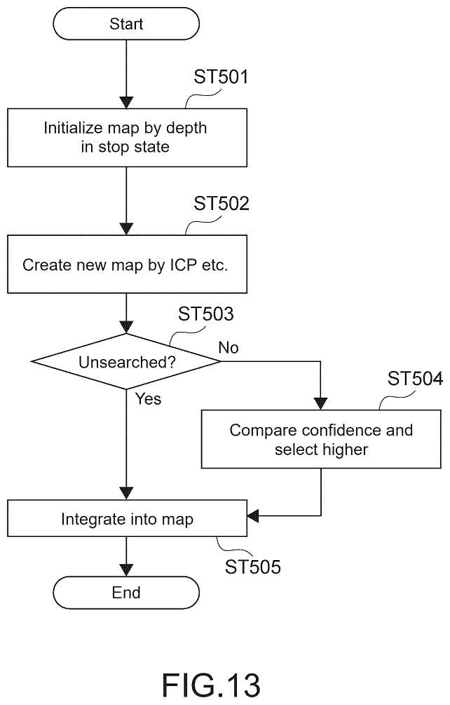

FIG. 13 is a flowchart showing a detailed process example of Step 105.

The map creation section 32 initializes the depth map 47 (Step 501).

In the present embodiment, for example, when the depth map 47 is created for the first time, the depth map 47 is first initialized.

The case where the depth map 47 is created for the first time is, for example, a moment when the small traveling robot 3 starts moving that corresponds to a case where the series of processes of Steps 101 to 105 shown in FIG. 4 is executed for the first time.

Also, even if the depth map 47 has been created in the past, initialization of the depth map 47 may be executed when there is a time period for which the depth map 47 has not been created for a while, for example, when the small traveling robot 3 has stopped for a certain amount of time.

Alternatively, when an initialization button for the initialization may be provided and the initialization button is pressed by a user (the delivery person or the like) who uses the small traveling robot 3, an initialization process may be executed.

In the initialization process, the map creation section 32 first creates the depth map 47 in a predetermined area with reference to the small traveling robot 3 in a state in which the small traveling robot 3 is stopped.

In the state in which the small traveling robot 3 is stopped, the map creation section 32 acquires a relatively high value as the confidence. For example, the confidence 1.0 is acquired, and the depth map 47 in which the confidence 1.0 is associated with each grid of 12 squares is created, as shown in A of FIG. 12.

On the other hand, in grids other than the grids of 12 squares around the small traveling robot 3, an unsearched area in which the confidence 0.0 is uniformly associated is created.

Since sensing is not executed in the unsearched area and the depth information is not acquired, the depth information is not associated with the unsearched area. However, an initial depth value such as “0” may be associated as a provisional depth value.

The map creation section 32A creates a new depth map 47 (Step 502).

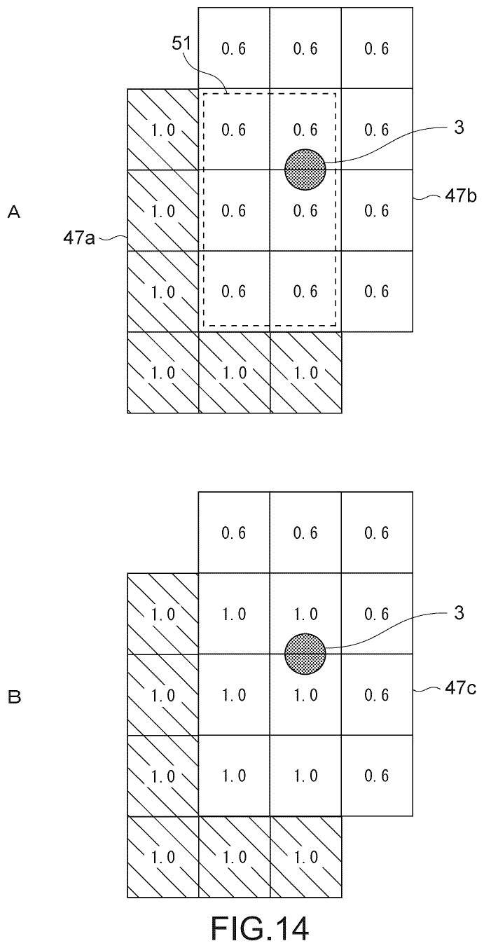

FIG. 14 is a schematic diagram of the depth map 47 created by the map creation section 32.

In A of FIG. 14, two depth maps 47 having grids of 12 squares are shown. In this figure, in order to distinguish the two depth maps 47, different signs such as a depth map 47a and a depth map 47b are used.

In A of FIG. 14, a state that after the depth map 47a is created, the small traveling robot 3 moves by one grid in the upward direction and by one grid in the rightward direction, and the new depth map 47b is created after the movement is shown.

As described above, the series of processes of Steps 101 to 105 shown in FIG. 4 is executed at any time (for example, at a predetermined frame rate) while the small traveling robot 3 is moving, and the new depth map 47b is continuously created.

In order to create the new depth map 47b, for example, an ICP (Iterative Closest Point) algorithm is used. The ICP is an algorithm that uses two point cloud data acquired by a sensor to calculate a position at which the point cloud data matches.

In the present embodiment, for example, the ICP is executed between the depth map 47b acquired once and the depth map 47a acquired just before to generate the depth map 47b after the ICP is executed. In this way, the depth map 47b is accurately corrected, and the new depth map 47b can be precisely generated.

In addition, the ICP may be used for estimating the self-position of the monocular camera 8 in Step 102 and estimating the depth in Step 103. For example, the ICP may be executed between the depth value acquired and the depth value acquired just before, and the acquired depth value may be corrected.

It should be appreciated that a method of creating the new depth map 47b is not limited to the method using the ICP, and an arbitrary method may be employed.

It is determined whether or not the new created depth map 47b is the depth map 47b for the unsearched area (Step 503).

In the present embodiment, in the initialization process of Step 501, the unsearched area having confidence of 0.0 is first created in a grid other than the 12 grids.

It is determined that the new depth map 47b is the depth map 47b for the unsearched area when the past created depth map 47a is not included in the new created depth map 47b.

On the other hand, it is determined that the new created depth map 47b is not the depth map 47b for the unsearched area when the past created depth map 47a is included in the new created depth map 47b (for example, when one or more grids of the new created depth map 47b overlap with the depth map 47a).

When it is determined that the depth map 47b is not the depth map 47b for the unsearched area (No in Step 503), then the confidence is compared (Step 504).

In A of FIG. 14, the state in which the depth map 47b is determined not to be the depth map 47b for the unsearched area is shown. Specifically, the upper right six grid areas of the past created depth map 47a are included in the depth map 47b.

In other words, upper right six grids of the depth map 47a (upper right two horizontal grids by three vertical grids) and lower left six grids of the depth map 47b (lower left two horizontal grids by three vertical grids) overlap. In a of FIG. 14, the overlap area, i.e., an overlap area 51, is shown by a rectangle filled with dashed lines.

The overlap area 51 is an area overlapping with the depth map 47b corresponding to the past created depth map 47a of the depth map 47b.

The confidence is compared on the overlap area 51.

Specifically, the map creation section 32 calculates the confidence having the highest value on the overlap area 51.

On the overlap area 51, the confidence of the depth map 47a is 1.0 and the confidence of the depth map 47b is 0.6. Therefore, as highest confidence on the overlap area 51, 1.0, which is the confidence of the depth map 47a, is calculated.

When it is determined that the depth map 47b is the depth map 47b for the unsearched area (Yes in Step 503), the depth map 47b is integrated (Step 505).

In this case, there is no overlap area 51 between the depth map 47a and the depth map 47b. When the depth map 47b is overwritten in the unsearched area, the integration is executed, and a post-integration depth map 47 including the depth map 47a and the depth map 47b is created.

On the other hand, when there is the overlap area 51, the confidence calculated in Step 504 that is a highest value in the overlap area 51 is associated with the overlap area 51.

In A of FIG. 14, a post-integration depth map 47c is shown.

The area that is originally the overlap area 51 in A of FIG. 14 (the middle six grids) is associated with the highest confidence 1.0. In addition, the confidence of the depth map 47a or the depth map 47b is directly associated with the area that is not originally the overlap area 51.

In addition, the depth information associated with the confidence having the highest value in the overlap area 51 is associated with the overlap area 51.

The depth information associated with the confidence 1.0, which is the highest confidence, is the confidence of the depth map 47a. Therefore, the depth information of the depth map 47a is associated with the area of the depth map 47c that is originally the overlap area 51.

In addition, the depth information of the depth map 47a or the depth map 47b is directly associated with the area that is not originally the overlap area 51.

Therefore, in the post-integration depth map 47c, the depth information and the confidence of the depth map 47a are associated with the area that is originally the overlap area 51.

In addition, the depth information and the confidence of the depth map 47a are associated with the area that is originally included in the depth map 47a and is not the overlap area 51.

In addition, the depth information and the confidence of the depth map 47b are associated with the area that is originally included in the depth map 47b and is not the overlap area 51.

In this way, the depth map 47a and the depth map 47b are integrated, and the depth map 47c is created.

That is, when the overlap area 51 is present and the new confidence is higher than the existing confidence, the integration is executed in such a manner that the confidence and the depth information are overwritten.

The post-integration depth map 47c is stored by the storage section 21, for example.

It should be appreciated that a specific method of the integration is not limited, and an arbitrary method may be used.

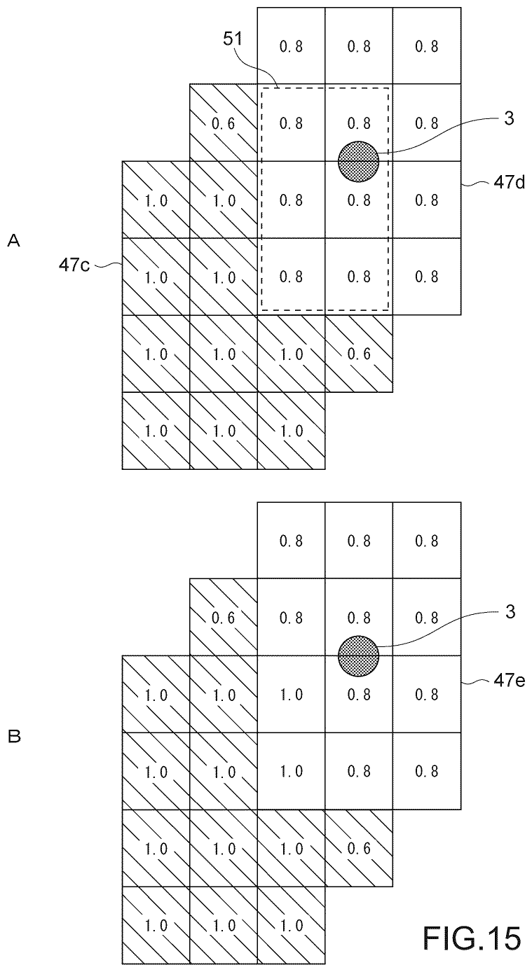

FIG. 15 is a schematic diagram of the depth map 47 created by the map creation section 32.

In A of FIG. 15, a state that after the depth map 47c of B of FIG. 14 is created by the integration, the small traveling robot 3 moves by one grid in the upward direction and by one grid in the rightward direction, and a new depth map 47d is created after the movement is shown.

The depth map 47d is uniformly associated with confidence 0.8.

Also in this case, the map creation section 32 compares the confidence on the overlap area 51.

The overlap area 51 is an area corresponding to the upper right six grids of the depth map 47c and the lower left six grids of the depth map 47d.

Of upper right six grids of the depth map 47c, the confidence of lower left two grids (lower left one horizontal grid by two vertical grids) is 1.0. In addition, the confidence of the four grids other than the lower left two grids is 0.6.

The confidence of lower left six grids of the depth map 47d is 0.8.

Therefore, in lower left two grids of the overlap area 51, the confidence 1.0 of the depth map 47c is compared with the confidence 0.8 of the depth map 47d. Then, the confidence 1.0 and the depth information of the depth map 47c are associated.

In four grids other than the lower left two grids, the confidence of the depth map 47c of 0.6 is compared with the confidence of the depth map 47d of 0.8. Then, the confidence 0.8 and the depth information of the depth map 47d are associated.

In this way, the depth map 47c and the depth map 47d are integrated. In B of FIG. 15, a post-integration depth map 47e is shown.

It is determined whether or not to end the generation process of the depth map 47 (Step 106).

When it is determined that the generation process is to be ended (Yes in Step 106), the process is ended.

For example, when the small traveling robot 3 arrives at the destination and the movement is ended, it is determined that the generation process of the depth map 47 is ended. The determination is executed by, for example, the map creation section 32.

When it is determined that the generation process is not to be ended (No in Step 106), a series of processes from Step 101 to Step 105 is executed again.

Note that the process order of Step 102 (self-position estimation) and Step 103 (depth estimation) is not limited. For example, the process of Step 103 may be executed first, or two processes may be executed in parallel.

### [Other Method of Calculating Depth Confidence]

The confidence calculation section 31 may calculate the confidence of the depth information based on confidence at the time of acquisition of the depth information calculated when the depth information is acquired.

Specifically, in a case where the depth estimation section 28 acquires the depth information in Step 103 (the depth estimation), the confidence at the time of acquisition of the depth information acquired may be possible to be calculated depending on the method of the depth estimation.

The confidence at the time of acquisition is a parameter representing how accurate the depth information acquired by the depth estimation section 28 is. For example, when the image information used to acquire the depth information is a blurred image, it is determined that the acquired depth information is also relatively inaccurate, and the confidence at the time of acquisition is calculated low.

It should be appreciated that a method of calculating the confidence at the time of acquisition is not limited and may be arbitrary. In addition, a machine learning algorithm or the like may be used to calculate the confidence at the time of acquisition.

Since the depth information is a different depth value for each grid, the confidence at the time of acquisition is also a different value for each grid.

The depth information acquired by the depth estimation section 28 and the confidence at the time of acquisition calculated are acquired by the confidence calculation section 31.

Furthermore, the confidence calculation section 31 calculates gap confidence.

The gap confidence is confidence calculated based on the first distance and the second distance.

For example, in a manner similar to that described in Step 404, using the absolute value of the difference between the height (A) and the shortest distance (B) |A−B| as the input, the gap confidence is calculated by the table 43 or the like.

In this case, the gap confidence is a parameter corresponding to the confidence calculated in Step 404.

It should be appreciated that the gap confidence may be calculated by other method based on the first distance and the second distance.

Furthermore, the confidence calculation section 31 calculates integrated confidence.

The integrated confidence is calculated based on the confidence at the time of acquisition and the gap confidence. Therefore, the parameters reflect accuracy of the acquired depth information and accuracy of the first distance and the second distance.

For example, the integrated confidence is calculated as a product of the confidence at the time of acquisition and the gap confidence. That is, it is calculated by the following formula:

Integrated confidence=confidence at the time of acquisition×gap confidence

For example, when the confidence at the time of acquisition is 0.5 and the gap confidence is 0.8, the calculated integrated confidence is 0.4.

The gap confidence has, for example, the same value in 12 grids uniformly, but since the confidence at the time of acquisition has a different value for each grid, the integrated confidence has also a different value for each grid.

The map creation section 32 creates the depth map 47 with which the integrated confidence is associated. Specifically, the integrated confidence and the depth information of the depth map 47 having highest integrated confidence in the overlap area 51 are associated with each other, and the depth map 47 is created.

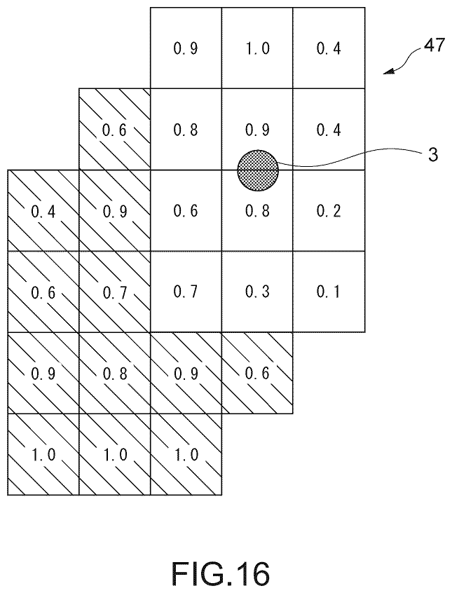

FIG. 16 is a schematic diagram of the depth map 47 to which the integrated confidence is associated.

As shown in FIG. 16, different integrated confidence is associated with the depth map 47 for each grid.

By using the integrated confidence, the confidence of the depth information acquired by the depth estimation section 28 (the confidence at the time of acquisition) is evaluated, and the depth map 47 is precisely created.

Note that a specific calculation method of the integrated confidence is not limited, and the integrated confidence may be calculated by an arbitrary method based on the confidence at the time of acquisition.

The integrated confidence corresponds to an embodiment of the confidence of the depth information calculated by the confidence calculation section based on the first distance and the second distance according to the present technology.

### [Traveling in the Sensing Area]

The traveling of the sensing area by the small traveling robot 3 will be described.

The movement control processing section 34 controls the movement of the small traveling robot 3 based on the depth map 47.

Specifically, the movement plan processing section 33 first acquires the depth map 47 created by the map creation section 32.

Then, the movement plan processing section 33 generates the movement plan of the small traveling robot 3 based on the acquired depth map 47.

For example, in the present embodiment, the position of the destination of the small traveling robot 3 and the presence or absence of an obstacle 48 are included in the depth map 47. Then, the movement plan processing section 33 generates, as the movement plan, a shortest route that can reach the destination in a shortest time (or a shortest distance) while avoiding the obstacle 48, based on the depth map 47.

The movement plan may include not only the shortest route but also a route that can safely reach the destination, and the like. In addition, any information about the movement such as the speed and acceleration of the small traveling robot 3 may be included.

The movement control processing section 34 controls the movement of the small traveling robot 3 based on the movement plan created by the movement plan processing section 33. Specifically, the movement control processing section 34 generates the control signal for controlling the specific movement of the actuator 22. Furthermore, the driving motor or the like included in the actuator 22 operates based on the generated control signal. Thereby, the movement of the small traveling robot 3 is realized.

The generation of the movement plan by the movement plan processing section 33 and a control of the movement by the movement control processing section 34 are included in the control of the movement according to the present technology.

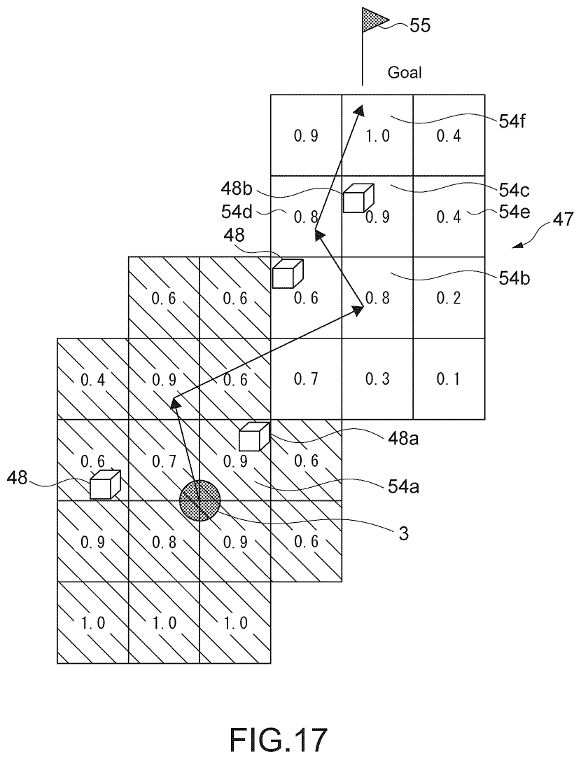

FIG. 17 is a schematic diagram showing an example of a movement path of the small traveling robot 3.

FIG. 17 shows the movement path of the small traveling robot 3 by arrows. Furthermore, the depth map 47 corresponding to the sensing area in which the small traveling robot 3 moves is shown.

Note that the depth map 47 is associated with different integrated confidence for each grid.

In the example shown in FIG. 17, the small traveling robot 3 is moving from an initial position (a position where the small traveling robot 3 is shown) toward a goal 55 that is the destination.

In a grid 54a at the initial position of the small traveling robot 3, it is determined that an obstacle 48a is present.

In the present embodiment, when the confidence of the depth information of the area in which the obstacle 48 is present in the sensing area is relatively high, the movement plan processing section 33 sets the obstacle 48 as a subject to be avoided.

For example, when a predetermined threshold such as “0.5” is set and the integrated confidence is higher than the threshold, the obstacle 48 is set as the subject to be avoided. In this example, the integrated confidence of the grid 54a is 0.9, which is higher than the threshold value. Therefore, the movement plan processing section 33 sets the obstacle 48a as the subject to be avoided. Then, the movement plan including a route for avoiding the obstacle 48a is generated.

Thus, the small traveling robot 3 can safely travel.

The small traveling robot 3 avoids the obstacle 48a and moves to a grid 54b.

In a grid 54c above the grid 54b, it is determined that an obstacle 48b is present.

Also in this case, since the integrated confidence of the grid 54c is 0.9 and is higher than the threshold value, the obstacle 48b is set as the subject to be avoided.

On the other hand, in both a grid 54d on the left side of the grid 54c and a grid 54e on the right side of the grid 54c, it is determined that the obstacle 48 is not present.

Therefore, as the movement path toward the goal 55 while avoiding the obstacle 48b, a path that reaches the goal 55 through the grid 54d and the grid 54f and a path that reaches the goal 55 through the grid 54e and the grid 54f are considered.

In this example, the integrated confidence of the grid 54d is 0.8, and the integrated confidence of the grid 54e is 0.4.

In this case, since the integrated confidence of the grid 54d is higher, it is determined that there is a low possibility that an error occurs in the depth estimation, and that there is a high possibility that the determination result that the obstacle 48 is not present is correct. That is, it is determined that there is a low possibility that the obstacle 48 is erroneously determined not to be present even though the obstacle 48 is actually present.

Then, the movement path to the grid 54d is selected. That is, the movement plan processing section 33 generates the movement plan including the grid 54d in the movement path, and the movement of the small traveling robot 3 is controlled.

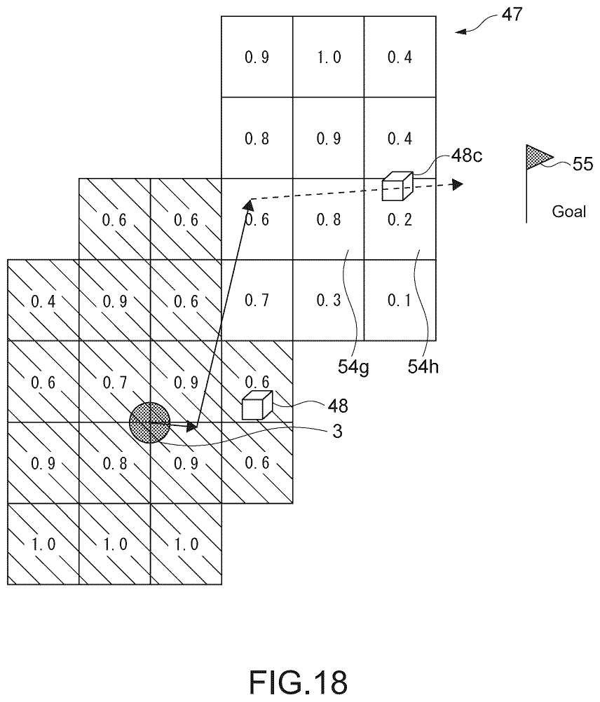

FIG. 18 is a schematic diagram showing an example of the movement path of the small traveling robot 3.

In the example shown in FIG. 18, the small traveling robot 3 first moves from the initial position to a grid 54g while avoiding the obstacle 48.

In order to move from the grid 54g to the goal 55, which is the destination, it needs to move while avoiding an obstacle 48c on a grid 54h.

Thus, for example, a conceivable path is such that it proceeds to a grid above and below the grid 54h to avoid the obstacle 48c.

However, the integrated confidence of the grid 54h is 0.2, which is lower.

In the present embodiment, when the confidence of the depth information of the area in which the obstacle 48 is present in the sensing area is relatively low, the movement plan processing section 33 does not set the obstacle 48 as the subject to be avoided.

For example, when a predetermined threshold value such as “0.5” is set and the integrated confidence is lower than the threshold value, even if it is determined that the obstacle 48 is present, the obstacle 48 is not set as the subject to be avoided.

In this example, the integrated confidence of the grid 54h is 0.2, which is lower than the threshold value. Therefore, the movement plan processing section 33 does not set the obstacle 48c as the subject to be avoided. Then, the movement plan including a path that does not avoid the obstacle 48c (a path passing through the grid 54h) is generated.

In this way, the movement plan may be created considering a possibility that an area with low confidence is included in the path and considering a balance. As a result, the small traveling robot 3 can efficiently travel.

The threshold value used to determine that the confidence of the depth information is relatively high or low may be an arbitrary value.

For example, if it is desired to make the small traveling robot 3 reach the destination quickly even at the expense of some safety, the threshold value is set high. By doing so, even in an area where it is determined that the obstacle 48 is present and the confidence is somewhat high, the movement plan that passes through the area is generated, and an arrival time to the destination is shortened.

On the other hand, if it is desired to prioritize safety even if it takes some time to reach the destination, the threshold value is set to be low. By doing so, when it is determined that the obstacle 48 is present even in an area with a somewhat lower confidence, the movement plan that avoids the area is generated, and the small traveling robot 3 can be safely moved.

Note that the method of determining whether or not the confidence of the depth information is relatively high or low is not limited to the method using the threshold, and an arbitrary method may be used.

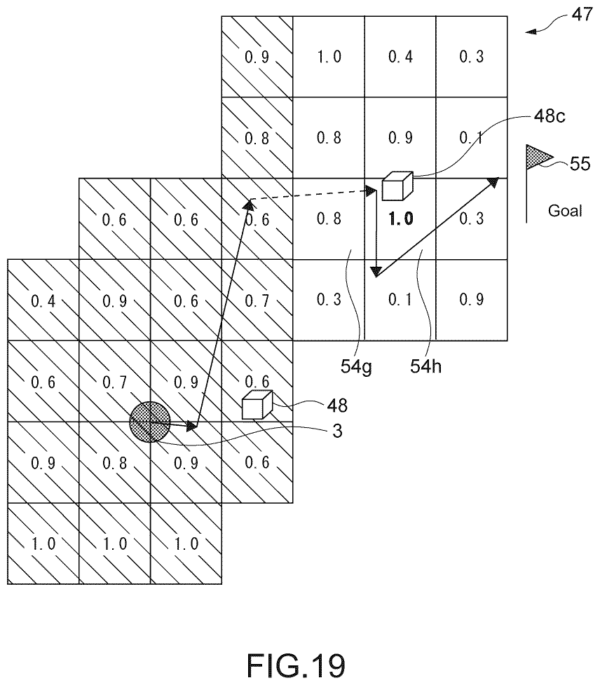

FIG. 19 is a schematic diagram showing an example of the movement path of the small traveling robot 3.

The example shown in FIG. 19 illustrates a state after the small traveling robot 3 reaches the grid 54g in FIG. 18 and the movement plan passing through the grid 54h is generated.

In this example, the new depth map 47 is created by the map creation section 32 when the small traveling robot 3 enters the grid 54h. FIG. 19 shows the new created depth map 47.

In the old depth map 47 of FIG. 18, the integrated confidence of the grid 54h is 0.2, whereas in the new depth map 47 of FIG. 19, the integrated confidence of the grid 54h is changed to 1.0.

In such a case, as shown in FIG. 19, the movement plan may be generated such that the small traveling robot 3 suddenly avoids the obstacle 48.

That is, even in a case where there is a low possibility that the obstacle 48 is present, in order to accurately confirm the presence or absence of the obstacle 48, the small traveling robot 3 executes sensing while traveling a little or stopping. Then, when the presence of the obstacle 48 is confirmed, a route of bypassing the obstacle 48 may be planned.

This makes it possible to realize a flexible movement in accordance with the change in the confidence.

By controlling the movement of the small traveling robot 3 based on the depth map 47, efficient traveling of the small traveling robot 3 is realized.

Any other specific method of controlling the movement of the small traveling robot 3 based on the depth map 47 is not limited.

As described above, in the small traveling robot 3 according to the present technology, the position of the monocular camera 8 is estimated based on the image information with respect to the sensing area, and the first distance between the monocular camera 8 and the sensing area is calculated. The second distance between the monocular camera 8 and the sensing area is calculated based on the depth information with respect to the sensing area. Based on the calculated first distance and the second distance, the confidence of the depth information with respect to the sensing area is calculated. By using the calculated confidence, it is possible to precisely create the map information.

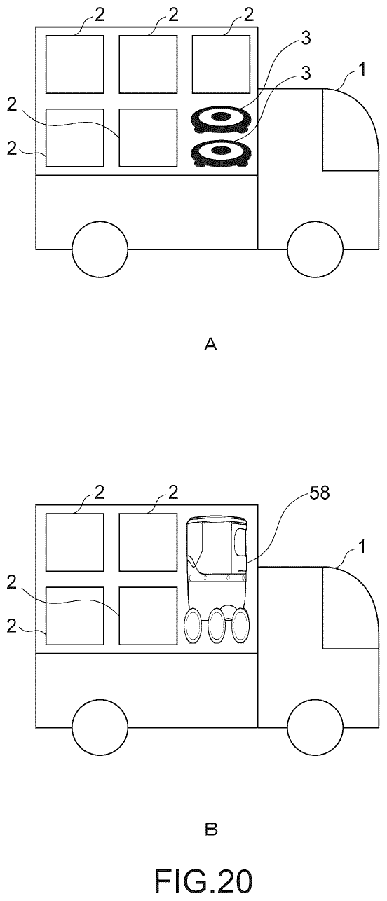

FIG. 20 is a schematic diagram of the small traveling robot 3 or the truck 1 loaded with the traveling robot 3.

A of FIG. 20 shows a state that the truck 1 loaded with the small traveling robot 3 according to the present technology similar to FIG. 1.

B of FIG. 20 shows a state that the truck 1 loaded with a traveling robot 58 as a comparative example.

As shown in B of FIG. 20, in a case where the truck 1 is loaded with the relatively large traveling robot 58, not so many traveling robots 58 and packages 2, i.e., one traveling robot 58 and four packages 2, cannot be loaded.

On the other hand, as shown in A of FIG. 20, when the small traveling robots 3 according to the present technology are loaded, more traveling robots 58 and packages 2, i.e., two traveling robots 58 and five packages 2, can be loaded as compared with the case of B of FIG. 20.

This makes it possible to simultaneously carry the packages 2 by the two small traveling robots 3 in a situation of the last mile delivery. Furthermore, the truck 1 can carry may packages 2 at a time.

That is, it is possible to contribute to the efficiency of logistics.

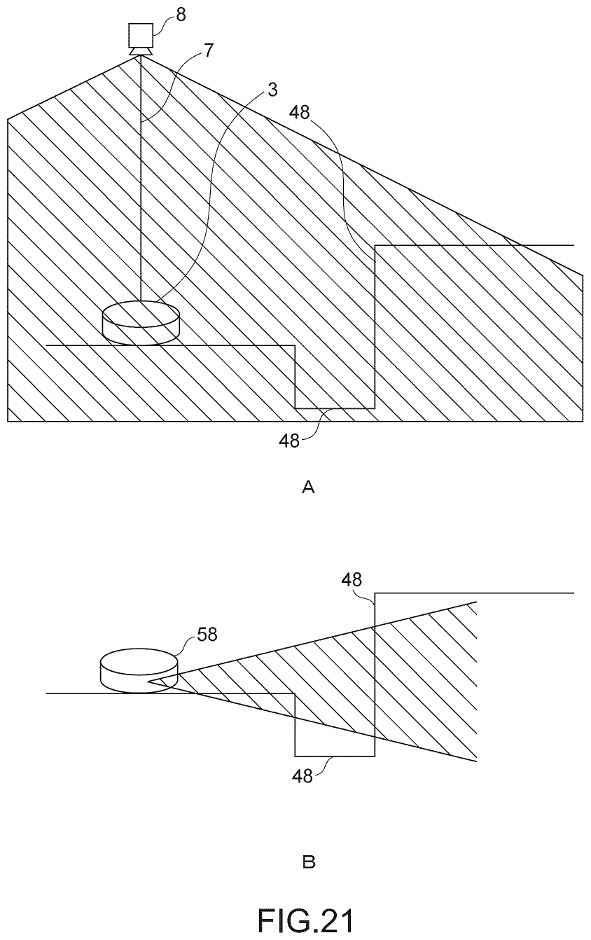

FIG. 21 is a schematic diagram of a sensing area of the small traveling robot 3 or the traveling robot 58.

A of FIG. 21 illustrates the sensing area of the small traveling robot 3 according to the present technology in a diagonal pattern.

B of FIG. 21 illustrates the sensing area of the traveling robot 58 as a comparative example.

In the example shown in B of FIG. 21, the sensing area of the traveling robot 58 is a space on a front side of the traveling robot 58.

The obstacle 48 (a hole and a wall surface) is present on the front side of the traveling robot 58. However, the sensing area does not include a bottom surface of the hole or a part (upper side and lower side) of the wall surface, and the entire hole and wall surface are not sensed.

As described above, in the traveling robot 58 in which the position of the sensor is low, such as the traveling robot 58 as the comparative example, information necessary for recognizing a surrounding environment cannot be sufficiently acquired, and thus a problem arises in that it is difficult to execute safe route planning.

Although it is possible to increase the height of the traveling robot 58 and install the sensor at a high position, there arises a problem that the traveling robot 58 tends to fall down. In addition, a storage location may be restricted.

On the other hand, as shown in A of FIG. 21, in the small traveling robot 3 according to the present technology, the monocular camera 8 is installed at the upper end portion of the pole 7 with the imaging direction directed downward. Then, the entire hole and wall surface are sensed so as to be a bird's-eye view of an entire ground surface.

This makes it possible to acquire a shape of the ground surface necessary for safe traveling, such as a depth of the hole and a height of the wall surface. Then, it is possible to determine whether or not the small traveling robot 3 can climb the wall surface.

In addition, it is possible to generate the depth map 47 in a wide area.

In addition, for example, when the small traveling robot 3 travels in the city, the pole 7 serves as a mark, and it is possible to urge the surrounding pedestrian or the like to pay attention.

For example, an accident in which the pedestrian or the like does not notice the presence of the small traveling robot 3 and collides with the small traveling robot 3 is prevented.

In the present embodiment, the confidence is calculated so that the confidence becomes higher as the difference between the first distance and the second distance becomes smaller.

This makes it possible to precisely evaluate the difference between the first distance and the second distance.

In addition, the depth map 47 in which the sensing area, the depth information, and the confidence are associated with each other is created. This makes it possible to create the high-quality depth map 47.

For example, as compared with the depth map with which only the sensing area and the depth information are associated, the depth map 47 is accurately created because confidence information is further included.

In addition, when there is the overlap area 51 with the past created depth map 47, the depth information associated with the confidence having the highest value in the overlap area 51 is used, and the depth map 47 is created.

By using such a method, the depth map 47 is precisely created.

In addition, the machine learning is executed using the result of the sensing area by the monocular camera 8 as the input, and depth information is acquired.

This makes it possible to precisely acquire the depth information with a simple sensor configuration.

### Other Embodiments

The present technology is not limited to the embodiments described above, and can realize various other embodiments.

In addition to the sensor capable of acquiring the image, the sensor capable of acquiring the depth information may be provided. For example, a ranging sensor such as LiDAR (Light Detection and Ranging, Laser Imaging Detection and Ranging) and a ToF (Time of Flight) sensor can be used. Alternatively, a sensor capable of acquiring both the image and the depth information, such as a stereo camera, may be used.

In this case, the process of acquiring the depth information based on the image information in Step 103 can be omitted.

It is not limited to the configuration in which the sensor is attached to an upper portion of the pole 7, and for example, a configuration in which the sensor is built in the moving object body 6 may be employed. The position of the sensor or the like may be appropriately determined within a range in which the present technology can be realized.

In addition, the small traveling robot 3 may include a plurality of sensors.

A pole whose length can be adjusted may be used as the pole 7.

As a result, for example, since a scale of the sensing is known, the sensing without using the feature points 14 becomes possible, and the present technology can be realized with a simple configuration.

A configuration including an IMU (Inertial Measurement Unit, inertial measurement device) may be employed.

This makes it possible to improve precision of the self-position estimation of the sensor and the moving object body 6.

By working together the computer mounted on the small traveling robot 3 with other computer capable of communicating via a network or the like, the information processing method according to the present technology may be executed and the information processing apparatus according to the present technology may be constructed.

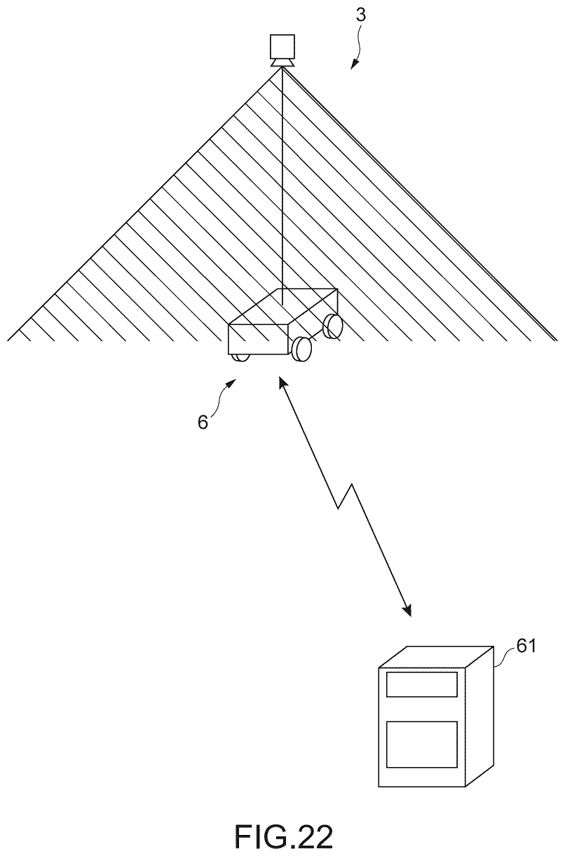

FIG. 22 is a schematic diagram of the small traveling robot 3 and a computer 61.

FIG. 22 illustrates the small traveling robot 3 and the computer 61 (such as a server device) configured externally.

For example, a portion or all of the functions of the various functional blocks are provided in the computer 61 capable of communicating via the network or the like. In this case, the small traveling robot 3 and the computer 61 may be provided with a communication function. It should be appreciated that other functional block that includes the communication function may be constructed and may be capable of working cooperatively with a “communication section”.

For example, the sensing result by the monocular camera 8 is transmitted from the small traveling robot 3 to the computer 61. Various functional blocks included in the computer 61 generate the depth map 47, the movement plan, and the like based on the sensing result. The generated movement plan and the like are transmitted to the small traveling robot 3 via the network or the like.

The “information control method” according to the present technology may be executed in such a configuration. Such a configuration can also be referred to as the “information processing system” according to the present technology.

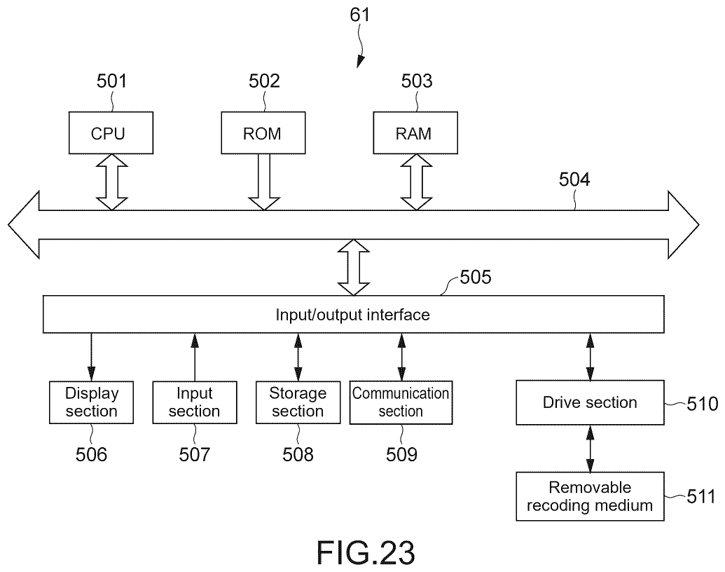

FIG. 23 is a block diagram showing a hardware configuration example of the computer 61.

The computer 61 includes a CPU 501, a ROM 502, a RAM 503, an input/output interface 505, and a bus 504 connecting them to each other. A display section 506, an input section 507, a storage section 508, a communication section 509, a drive section 510, and the like are connected to the input/output interface 510.

The display section 506 is, for example, a display device using liquid crystal, EL, or the like. The input section 507 is, for example, a keyboard, a pointing device, a touch panel, or other operating device. In a case where the input section 507 includes the touch panel, the touch panel can be integrated with the display section 506.

The storage section 508 is a non-volatile storage device and is, for example, an HDD, a flash memory, or other solid-state memory. The drive section 98 is, for example, a device capable of driving a removable recoding medium 511 such as an optical recording medium and a magnetic recording tape.

The communication section 509 is a modem, a router, or other communication device for communicating with other devices, which can be connected to a LAN, a WAN, or the like. The communication section 509 may be one that executes communication wired or wirelessly. The communication section 509 is often used separately from the computer 61.

The information processing by the computer 61 having the hardware configuration as described above is realized by cooperation of software stored in the storage section 508, the ROM 502, or the like, and hardware resources of the computer 61. Specifically, the information processing method according to the present technology is realized by loading the program configuring the software stored in the ROM 502 or the like into the RAM 503 and executing the program.

The program is installed in the computer 61 via the removable recording medium 511, for example. Alternatively, the program may be installed in the computer 61 via a global network or the like. In addition, an arbitrary non-transitory storage medium that can be read by the computer 61 may be used.

The information processing method according to the present technology may be executed to construct the information processing apparatus according to the present technology by cooperation of a plurality of connected computers capable of communicating via the network or the like.

That is, the information processing method according to the present technology can be executed not only in a computer system including a single computer but also in a computer system in which a plurality of computers works together.

Note that, in the present disclosure, the system refers to a set of plural components (such as apparatuses and modules (pars)) and it does not matter whether or not all of the components are in the same housing. Thus, a plurality of apparatuses accommodated in separate housings and connected via the network, and a single apparatus in which a plurality of modules is accommodated in a single housing are both the system.

Execution of the information processing method according to the present technology by the computer system includes both of, for example, a case where the sensing by the sensor, the acquisition of the image information and the depth information, the position estimation of the sensor, the calculation of the distance, the calculation of the confidence, the creation of the depth map, the generation of the movement plan, the control of the movement, and the like are executed by a single computer, and a case where each process is executed by different computers. Furthermore, the execution of each process by a predetermined computer includes causing other computer to execute a portion of or all of the processes and acquiring a result thereof.

That is, the information processing method according to the present technology can be also applied to a configuration of cloud computing in which single function is shared and collaboratively processed by a plurality of apparatuses via the network.

The configuration of the small traveling robot, the creation of the depth map, the control of the movement, each process flow, and the like described with reference to the drawings are merely one embodiment, and can be arbitrarily modified without departing from the spirit of the present technology. In other words, for example, other arbitrary configurations or algorithms for implementing the present technology may be employed.

In the present disclosure, in a case where the word “approximately” is used, it is used only to facilitate the understanding of the description, and the use/non-use of the word “approximately” has no special meaning.

In other words, in the present disclosure, a concept defining a shape, a size, a positional relationship, a state, and the like, such as “center”, “central”, “uniform”, “equal”, “same”, “orthogonal”, “parallel”, “symmetric”, “extending”, “axial direction”, “columnar shape”, “cylindrical shape”, “ring shape”, “annular shape”, “rectangular shape”, “star shape”, or the like is a concept including “substantially center”, “substantially central”, “substantially uniform”, “substantially equal”, “substantially same”, “substantially orthogonal”, “substantially parallel”, “substantially symmetric”, “substantially extending”, “substantially axial direction”, “substantially columnar shape”, “substantially cylindrical shape”, “substantially ring shape”, “substantially annular shape”, “substantially rectangular shape”, “substantially star shape”, or the like.

For example, it also includes a state included in a predetermined range (for example, a range of ±10%) based on “completely center”, “completely central”, “completely uniform”, “substantially equal”, “completely same”, “completely orthogonal”, “completely parallel”, “completely symmetric”, “completely extending”, “completely axial direction”, “completely columnar shape”, “completely cylindrical shape”, “completely ring shape”, “completely annular shape”, “completely rectangular shape”, “completely star shape”, or the like.

Therefore, even in a case where the word “approximately” is not added, a concept expressed by adding a so-called “approximately” can be included. On the contrary, the complete state is not excluded from the state expressed by adding “approximately”.

In the present disclosure, expressions using “than” such as “larger than A” and “smaller than A” are expressions comprehensively including both the concept including a case where it is equivalent to A and the concept not including a case where it is equivalent to A. For example, “larger than A” is not limited to the case not including being equivalent to A and includes “A or more”. Furthermore, “smaller than A” is not limited to “less than A” and includes “A or less”.

When implementing the present technology, specific setting and the like may be appropriately employed from the concept included in “larger than A” and “smaller than A” such that the effects described above are exhibited.

At least two of the features of the present technology described above can also be combined. In other words, various features described in the respective embodiments may be combined arbitrarily regardless of the embodiments. Furthermore, the various effects described above are merely illustrative but are not limitative, and other effects may be provided.

Note that the present technology may also have the following configurations.

(1)

An information processing apparatus, including:
an acquisition section for acquiring each of image information and depth information with respect to a sensing area of a sensor capable of acquiring the image information based on a sensing result of the sensor;
a first calculation section for estimating a position of the sensor based on the image information to calculate a first distance between the sensor and the sensing area based on the estimated position of the sensor;
a second calculation section for calculating a second distance between the sensor and the sensing area based on the depth information; and
a confidence calculation section for calculating confidence of the depth information based on the first distance and the second distance.
   (2) The information processing apparatus according to (1), in which
the confidence calculation section calculates the confidence of the depth information based on a difference between the first distance and the second distance.
   (3) The information processing apparatus according to (2), in which
the confidence calculation section calculates the confidence of the depth information so that the confidence of the depth information increases as the difference between the first distance and the second distance decreases.
   (4) The information processing apparatus according to any one of (1) to (3),
the sensor is installed on a moving object body configured to be movable on a ground and is movable integrally with the moving object body,
the sensing area includes a peripheral area of the moving object body of the ground,
the first calculation section calculates a shortest distance between the sensor and the peripheral area as the first distance,
the second calculation section calculates a shortest distance between the sensor and the peripheral area as the second distance.
   (5) The information processing apparatus according to (4), in which
the sensor is installed at a position on an upper side of the moving object body toward a lower side.
   (6) The information processing apparatus according to (4) or (5), in which
the first calculation section calculates a height of the sensor with respect to the moving object body based on the image information, and calculates a total value of the calculated height of the sensor with respect to the moving object body and the height of the moving object body as the first distance.
   (7) The information processing apparatus according to (6), in which
the moving object body includes a surface included in the sensing area and having feature points arranged thereon, and
the first calculation section calculates the height of the sensor with respect to the moving object body based on image information about the feature points.
information processing apparatus.
   (8) The information processing apparatus according to any one of (4) to (7),
the second calculation section calculates a shortest distance between the sensor and the sensing area as a candidate shortest distance based on the depth information, and when the candidate shortest distance is a shortest distance between the sensor and the moving object body, calculates a total value of the candidate shortest distance and the height of the moving object body as the second distance.
   (9) The information processing apparatus according to any one of (1) to (8), further including:
a map creation section for creating a depth map in which the sensing area, the depth information, and the confidence of the depth information are associated with each other.
   (10) The information processing apparatus according to (9), in which
when there is an overlap area overlapping with the sensing area corresponding to the depth map created in the past in the sensing area, the map creation section creates the depth map using the depth information associated with the confidence of the depth information having a highest value in the overlap area.
   (11) The information processing apparatus according to any one of (1) to (10),
the confidence calculation section calculates the confidence of the depth information based on confidence at the time of acquisition of the depth information calculated when the depth information is acquired.
   (12) The information processing apparatus according to (9) or (10), further including:
a movement control section for controlling a movement of the moving object based on the depth map.
   (13) The information processing apparatus according to (12), in which
the depth map includes presence or absence of an obstacle on the sensing area, and
when the confidence of the depth information of an area in which the obstacle is present in the sensing area is relatively high, the movement control section sets the obstacle as a subject to be avoided.
   (14) The information processing apparatus according to (12) or (13), in which
the depth map includes presence or absence of an obstacle on the sensing area, and
when the confidence of the depth information of an area in which the obstacle is present in the sensing area is relatively low, the movement control section does not set the obstacle as a subject to be avoided.
   (15) The information processing apparatus according to any one of (1) to (14), in which
the sensor is a monocular camera, and
the acquisition section acquires the depth information by executing machine learning using the sensing result of the monocular camera as an input.
   (16) The information processing apparatus according to any one of (1) to (15), in which
the sensor is installed on the moving object body configured to be movable on the ground and is movable integrally with the moving object body, and
the information processing apparatus further includes
the sensor, and
the moving object body.
   (17) The information processing apparatus according to any one of (1) to (16), in which
the sensor is installed on the moving object body configured to be movable on the ground and is movable integrally with the moving object body, and is configured to be attachable to and detachable from the moving object body.
   (18) An information processing method executed by a computer system, including:
acquiring each of image information and depth information with respect to a sensing area of a sensor capable of acquiring the image information based on a sensing result of the sensor;
estimating a position of the sensor based on the image information to calculate a first distance between the sensor and the sensing area based on the estimated position of the sensor;
calculating a second distance between the sensor and the sensing area based on the depth information; and
calculating confidence of the depth information based on the first distance and the second distance.
   (19) A program that causes a computer system to execute:
a step of acquiring each of image information and depth information with respect to a sensing area of a sensor capable of acquiring the image information based on a sensing result of the sensor;
a step of estimating a position of the sensor based on the image information to calculate a first distance between the sensor and the sensing area based on the estimated position of the sensor;
a step of calculating a second distance between the sensor and the sensing area based on the depth information; and
a step of calculating confidence of the depth information based on the first distance and the second distance.

### REFERENCE SIGNS LIST

3 small traveling robot
6 moving object body
8 monocular camera
11 upper surface
14 feature point
17 controller
24 image acquisition section
25 feature point extraction section
26 self-position estimation section
27 first calculation section
28 depth estimation section
29 recognition section
30 second calculation section
31 confidence calculation section
32 map creation section
33 movement plan processing section
34 movement control processing section
37 surrounding ground
40 imaging range
47 depth map
48 obstacle
51 overlap area

1. An information processing apparatus, comprising:
an acquisition section for acquiring each of image information and depth information with respect to a sensing area of a sensor capable of acquiring the image information based on a sensing result of the sensor;
a first calculation section for estimating a position of the sensor based on the image information to calculate a first distance between the sensor and the sensing area based on the estimated position of the sensor;
a second calculation section for calculating a second distance between the sensor and the sensing area based on the depth information; and
a confidence calculation section for calculating confidence of the depth information based on the first distance and the second distance.

2. The information processing apparatus according to claim 1, wherein
the confidence calculation section calculates the confidence of the depth information based on a difference between the first distance and the second distance.

3. The information processing apparatus according to claim 2, wherein
the confidence calculation section calculates the confidence of the depth information so that the confidence of the depth information increases as the difference between the first distance and the second distance decreases.

4. The information processing apparatus according to claim 1,
the sensor is installed on a moving object body configured to be movable on a ground and is movable integrally with the moving object body,
the sensing area includes a peripheral area of the moving object body of the ground,
the first calculation section calculates a shortest distance between the sensor and the peripheral area as the first distance,
the second calculation section calculates a shortest distance between the sensor and the peripheral area as the second distance.

5. The information processing apparatus according to claim 4, wherein
the sensor is installed at a position on an upper side of the moving object body toward a lower side.

6. The information processing apparatus according to claim 4, wherein
the first calculation section calculates a height of the sensor with respect to the moving object body based on the image information, and calculates a total value of the calculated height of the sensor with respect to the moving object body and the height of the moving object body as the first distance.

7. The information processing apparatus according to claim 6, wherein
the moving object body includes a surface included in the sensing area and having feature points arranged thereon, and
the first calculation section calculates the height of the sensor with respect to the moving object body based on image information about the feature points.
information processing apparatus.

8. The information processing apparatus according to claim 4,
the second calculation section calculates a shortest distance between the sensor and the sensing area as a candidate shortest distance based on the depth information, and when the candidate shortest distance is a shortest distance between the sensor and the moving object body, calculates a total value of the candidate shortest distance and the height of the moving object body as the second distance.

9. The information processing apparatus according to claim 1, further comprising:
a map creation section for creating a depth map wherein the sensing area, the depth information, and the confidence of the depth information are associated with each other.

10. The information processing apparatus according to claim 9, wherein
when there is an overlap area overlapping with the sensing area corresponding to the depth map created in the past in the sensing area, the map creation section creates the depth map using the depth information associated with the confidence of the depth information having a highest value in the overlap area.

11. The information processing apparatus according to claim 1,
the confidence calculation section calculates the confidence of the depth information based on confidence at the time of acquisition of the depth information calculated when the depth information is acquired.

12. The information processing apparatus according to claim 9, further comprising:
a movement control section for controlling a movement of the moving object based on the depth map.

13. The information processing apparatus according to claim 12, wherein
the depth map includes presence or absence of an obstacle on the sensing area, and
when the confidence of the depth information of an area wherein the obstacle is present in the sensing area is relatively high, the movement control section sets the obstacle as a subject to be avoided.

14. The information processing apparatus according to claim 12, wherein
the depth map includes presence or absence of an obstacle on the sensing area, and
when the confidence of the depth information of an area wherein the obstacle is present in the sensing area is relatively low, the movement control section does not set the obstacle as a subject to be avoided.

15. The information processing apparatus according to claim 1, wherein
the sensor is a monocular camera, and
the acquisition section acquires the depth information by executing machine learning using the sensing result of the monocular camera as an input.

16. The information processing apparatus according to claim 1, wherein
the sensor is installed on the moving object body configured to be movable on the ground and is movable integrally with the moving object body, and
the information processing apparatus further includes
the sensor, and
the moving object body.

17. The information processing apparatus according to claim 1, wherein
the sensor is installed on the moving object body configured to be movable on the ground and is movable integrally with the moving object body, and is configured to be attachable to and detachable from the moving object body.

18. An information processing method executed by a computer system, comprising:
acquiring each of image information and depth information with respect to a sensing area of a sensor capable of acquiring the image information based on a sensing result of the sensor;
estimating a position of the sensor based on the image information to calculate a first distance between the sensor and the sensing area based on the estimated position of the sensor;
calculating a second distance between the sensor and the sensing area based on the depth information; and
calculating confidence of the depth information based on the first distance and the second distance.

19. A program that causes a computer system to execute:
a step of acquiring each of image information and depth information with respect to a sensing area of a sensor capable of acquiring the image information based on a sensing result of the sensor;
a step of estimating a position of the sensor based on the image information to calculate a first distance between the sensor and the sensing area based on the estimated position of the sensor;
a step of calculating a second distance between the sensor and the sensing area based on the depth information; and
a step of calculating confidence of the depth information based on the first distance and the second distance.
